(19) United States
(12) Patent Application Publication
(10) Pub. No.: US 2011/0027664 A1
(43) Pub. Date: Feb. 3, 2011

(54) METAL-AIR BATTERY WITH IMPROVED ENVIRONMENTAL STABILITY

(75) Inventors: Trygve Burchardt, Maennedorf (CH); Michael Lanfranconi, Horgen (CH)

Correspondence Address: FOLEY & LARDNER LLP, 777 EAST WISCONSIN AVENUE, MILWAUKEE, WI, 53202-5306, US

(73) Assignee: ReVolt Technology Ltd.

(21) Appl. No.: 12/847,405

(22) Filed: Jul. 30, 2010

Related U.S. Application Data
(60) Provisional application No. 61/230,550, filed on Jul. 31, 2009.
(60) Provisional application No. 61/304,273, filed on Feb. 12, 2010.

(51) Int. Cl. H01M 12/02; H01M 2/16

(52) U.S. Cl. 429/403

(57) ABSTRACT

A metal-air battery includes a metal electrode, an air electrode, and at least one of an ionic liquid and a deep eutectic solvent provided within the metal-air battery. The ionic liquid and/or deep eutectic solvent may be provided at one or more locations within the battery, such as in a liquid electrolyte, within a polymeric separator, blended within a polymeric material, within the structure of the air electrode, or elsewhere.

### CROSS-REFERENCE TO RELATED PATENT APPLICATIONS

The present application claims priority to and the benefit of U.S. Provisional Patent Application No. 61/230,550, filed Jul. 31, 2009, and U.S. Provisional Patent Application No. 61/304,273, filed Feb. 12, 2010, the entire disclosures of which are incorporated herein by reference.

### BACKGROUND

The present application relates generally to the field of batteries and components for batteries. More specifically, the present application relates to the use of processes, materials, and structures/components to manage the interaction between the internal chemical reaction in a metal-air battery and the external environment. The concepts disclosed herein are further applicable to metal-air fuel cells.

Metal-air batteries include a negative metal electrode (e.g., zinc, aluminum, magnesium, iron, lithium, etc.) and a positive electrode having a porous structure with catalytic properties for an oxygen reaction (typically referred to as the air electrode for the battery). An electrolyte is used to maintain high ionic conductivity between the two electrodes. For alkaline metal-air batteries (i.e., having an alkaline electrolyte), the air electrode is usually made from thin, porous polymeric material (e.g., polytetrafluoroethylene) bonded carbon layers. To prevent a short circuit of the battery, a separator is provided between the negative electrode (anode) and the positive electrode (cathode).

During discharging of the metal-air batteries, oxygen from the atmosphere is converted to hydroxyl ions in the air electrode. The reaction in the air electrode involves the reduction of oxygen, the consumption of electrons, and the production of hydroxyl ions. The hydroxyl ions migrate through the electrolyte toward the metal negative electrode, where oxidation of the metal of the negative electrode occurs, forming oxides and liberating electrons. In a secondary (i.e., rechargeable) metal-air battery, charging converts hydroxyl ions to oxygen in the air electrode, releasing electrons. At the metal electrode, the metal oxides or ions are reduced to form the metal while electrons are consumed.

Metal-air batteries provide significant energy capacity benefits. For example, metal-air batteries have several times the energy storage density of lithium-ion batteries, while using globally abundant and low-cost metals (e.g., zinc) as the energy storage medium. The technology is relatively safe (non-flammable) and environmentally friendly (non-toxic and recyclable materials may be used). Since the technology uses materials and processes that are readily available in the U.S. and elsewhere, dependence on scarce resources such as oil may be reduced.

A metal-air battery is a partially open system, in which the air electrode utilizes oxygen from the surrounding environment. One challenge associated with such an open system is that environmental conditions such as humidity and the presence of carbon dioxide (CO₂) may impact the battery, and in some cases may significantly shorten the lifespan of the battery. This in turn may limit the possible applications in which conventional metal-air batteries may be used.

It has been observed that relatively low humidity in the surrounding environment (e.g., less than 45 percent relative humidity) may cause undesirable drying out of the electrolyte. Drying out of the metal-air battery causes an increase in ohmic resistance, and, subsequently, a loss in the power density and efficiency of the battery. Further, with relatively long term exposure in dry environments, the electrolyte can dry out completely, causing irreversible battery failure.

It has further been observed that when the humidity in the surrounding environment is relatively high (e.g., greater than 45 percent relative humidity), the electrode may flood. For example, where the humidity is relatively high, moisture will be taken into the metal-air battery, causing a fall in electrolyte concentration and an increase in volume. The discharge performance of the metal-air battery will consequently be reduced and leakage of the electrolyte may occur.

The presence of CO₂ has been reported to adversely affect the performance and lifetime of metal-air batteries. It has been suggested that CO₂ may cause the pore structure of the air electrode to close up and that CO₂ may also cause a loss of conductivity (e.g., by displacing OH⁻ (hydroxide) ions with CO₃²⁻). Although CO₂ may enter a metal-air battery from the external environment, it has also been suggested that CO₂ may be generated internally by the metal-air battery itself (e.g., through oxidation of the carbon support) when the air electrode includes carbon and is used for charge as a bifunctional air electrode.

In order to address issues associated with undesirable environmental conditions for metal-air batteries and fuel cells, others have suggested the use of peripheral systems (e.g., fans, valves, humidifiers, CO₂ scrubbers, etc.) to control the impact that the external environment may have. Obvious shortcomings of such solutions include increased cost and complexity of the system, increased size (thus giving a lower effective energy density), and the fact that such solutions may not be suitable for use in certain applications (e.g., one would not want to use an external fan for a hearing aid battery).

It would be advantageous to provide an improved battery and structures/features therefor that address one or more of the foregoing issues. It would also be advantageous to provide materials and structures in a metal-air battery that provide for management of the interaction between the internal chemical reaction in the battery and the external environment. It would also be advantageous to provide a metal-air battery having a longer lifespan. It would also be advantageous to provide a metal-air battery that may be used in a variety of applications, including, but not limited to, large scale and small scale applications. Other advantageous features of the battery disclosed herein will be apparent to those reviewing the present disclosure.

### SUMMARY

An exemplary embodiment relates to a metal-air battery that includes a metal electrode, an air electrode, and at least one of an ionic liquid and a deep eutectic solvent provided within the metal-air battery.

Another exemplary embodiment relates to a metal-air battery that includes a metal anode, an air electrode, and an electrolyte provided between the metal anode and the air electrode. The metal-air battery includes at least one polymeric separator between the metal anode and the air electrode. At least one of an ionic liquid and a deep eutectic solvent is provided within the electrolyte, within the polymeric separator, or in a layer of material coupled to the air electrode.

Another exemplary embodiment relates to a metal-air battery that includes a metal anode, an air electrode, an electrolyte provided between the metal anode and the air electrode, and at least one polymeric separator between the metal anode and the air electrode. At least one of an ionic liquid and a deep eutectic solvent is provided adjacent the air electrode.

### BRIEF DESCRIPTION OF THE DRAWINGS

FIG. 1 is a perspective view of a metal-air battery in the form of a coin cell according to an exemplary embodiment.

FIG. 2 is a cross-sectional view of the metal-air battery shown in FIG. 1.

FIG. 2A is a is a cross-sectional view of a metal-air battery similar to that shown in FIG. 1 according to another exemplary embodiment.

FIGS. 3A, 3B, 3C, 3D, 3E, 3F, and 3G are cross-sectional views of portions of metal-air batteries according to various exemplary embodiments.

FIG. 4 is a perspective view of a metal-air battery having a prismatic configuration according to an exemplary embodiment.

FIG. 5 is a cross-sectional view of the metal-air battery shown in FIG. 4.

FIG. 6 is detail cross-sectional view of the cross-section shown in FIG. 5.

FIG. 7 is a partially exploded perspective view of a flow battery according to an exemplary embodiment.

FIGS. 8-24 are graphs illustrating various test data.

### DETAILED DESCRIPTION

According to an exemplary embodiment, a metal-air battery or cell is provided that exhibits improved stability and performance when exposed to water vapor (e.g., the relative humidity) and other component elements of its surrounding environment (e.g., CO₂). The metal-air battery is configured to substantially retain water when the surrounding environment has low humidity, to resist flooding when the surrounding environment has high humidity, and to transition effectively between low and high humidity environments without substantially sacrificing these benefits. The metal-air battery is also configured to reduce undesirable effects that may result from exposure to CO₂. According to an exemplary embodiment, one or more materials and structures/components may be incorporated into a metal-air battery to provide an improved lifespan without compromising high current density for the battery, enabling the battery to be used for a wide range of applications.

According to an exemplary embodiment, the battery includes an ionic liquid and/or a deep eutectic solvent within the battery that is positioned adjacent the air electrode. As will be discussed in greater detail below, the use of such materials advantageously allows the battery to retain a desired performance level by preventing the drying out of the electrolyte and the air electrode.

The metal-air battery may have any desired configuration, including, but not limited to coin or button cells, prismatic cells, cylindrical cells (e.g., AA, AAA, C, or D cells, or other cylindrical battery configurations), oval cells, flow cells, etc., or may have a fuel cell configuration. Further, the metal-air battery may be a primary (disposable, single-use) or a secondary (rechargeable) battery

To operate a metal-air battery with high stability, the air humidity is desirably balanced against the vapor pressure of H₂O within the metal-air battery. To achieve this balance, at least three methods are in principle possible.

First, peripheral systems, such as an oxygen humidifier and/or a CO₂ scrubber, may be used. The use of peripheral systems involves treatment of the air before it enters the metal-air battery to control the humidity. As mentioned above, the primary drawbacks of this method are the increased size and cost of the battery.

Second, a modified electrolyte may be used. The objective of using a modified electrolyte is to slow down or reverse the drying of the cell, for instance, by polymerizing the electrolyte to trap water within the electrolyte and reduce the loss of humidity.

Third, a selective membrane may be used. A selective membrane is a membrane that reduces transport of an undesirable environmental element, but allows transport of a desirable element (e.g., low H₂O and CO₂ transport, high O₂ transport). It is beneficial to provide a selective membrane capable of sufficiently slowing down/preventing water vapor and CO₂ transport to provide for a satisfactory battery lifetime, while not limit the oxygen transport to such a degree that the power capability of the battery is reduced.

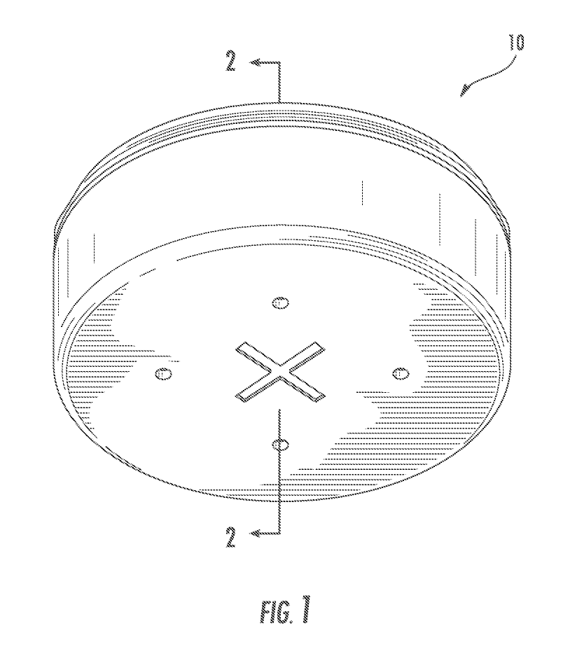

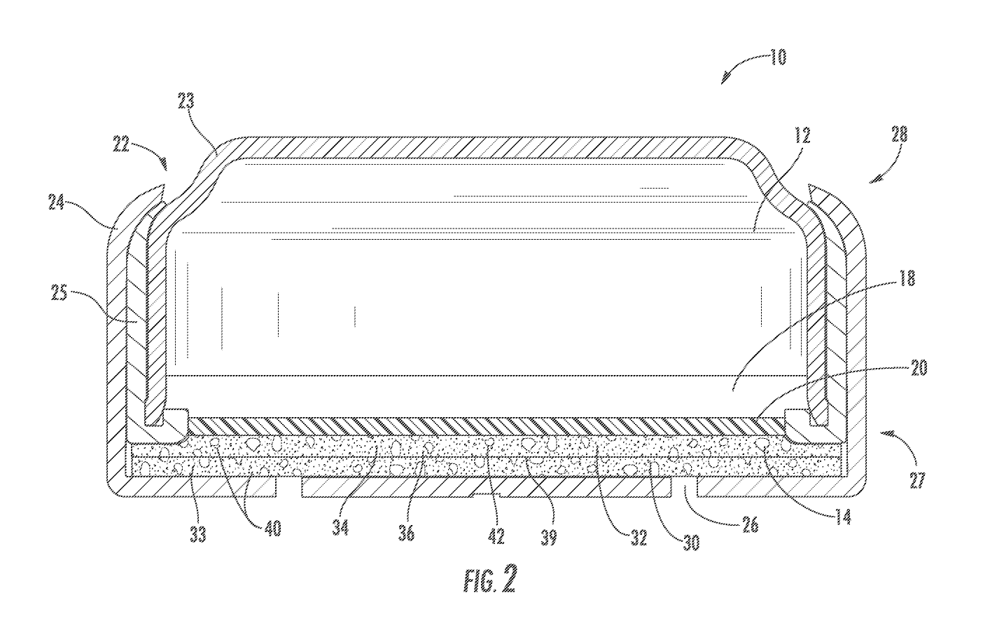

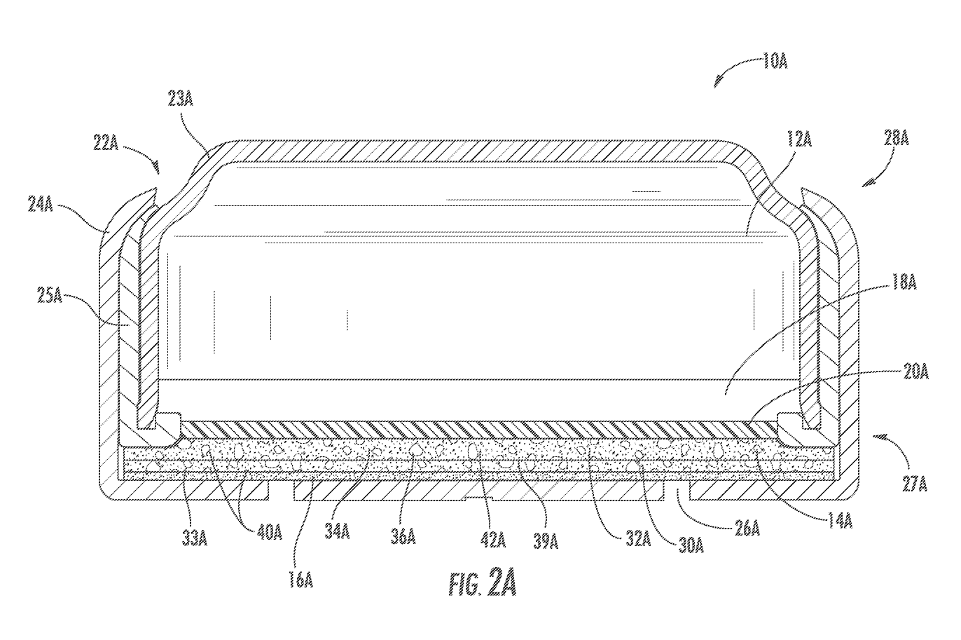

Referring to FIGS. 1-2, a metal-air battery or cell 10 shown in the form of a coin or button cell is illustrated according to an exemplary embodiment. The battery 10 includes a metal electrode 12, an air electrode 14, an optional oxygen-selective membrane in the form of a siloxane membrane 16 (see, e.g., FIG. 2A, which illustrates an exemplary embodiment of a metal-air battery 10A similar to that shown in FIG. 2, with the exception of the fact that the metal-air battery 10A includes a siloxane membrane 16A; it should be noted that similar reference numerals in FIG. 2A refer to similar elements as shown and described with respect to FIG. 2 with the exception of the fact that they use the letter “A” after the reference numeral, and that a similar convention is used with respect to other of the drawing figures described herein), an electrolyte 18, a separator layer 20, and an enclosing structure shown as a housing 22 according to an exemplary embodiment.

According to an exemplary embodiment, the battery 10 is a zinc-air battery. According to other exemplary embodiments, the battery 10 may use other metals in place of the zinc, including, but not limited to, aluminum, magnesium, iron, lithium, cadmium, and/or a metal hydride. Examples of metal hydride materials include the AB₅ or AB₂ structure types where the “ABₓ” designation refers to the ratio of A elements and B elements. For the AB₅ type, A may be a combination of La, Ce, Pr and Nd, and, for the AB₂ type, A may be Ti, Zr or a combination of Ti and Zr. For both structure types, B may be a combination of Ni, Mn, Co, Al and Fe.

Referring further to FIG. 2, the housing 22 (e.g., case, container, casing, etc.) is shown as including a base 23 and a lid 24 according to an exemplary embodiment. A seal 25 (e.g., a molded nylon or Teflon sealing gasket, etc.) is formed or disposed generally between the base 23 (e.g., can, etc.) and the lid 24 (e.g., cap, cover, top, etc.) to help maintain the relative positions of the base 23 and the lid 24. The seal 25 also helps prevent undesirable contacts (e.g., causing a short circuit) and/or leakage. The lid 24 includes one or more holes 26 (e.g., apertures, openings, slots, recesses, etc.) at a first portion 27 of the housing 22 generally opposite a second portion 28. The metal electrode 12 is shown disposed within the housing 22 at or proximate to the second portion 28. The air electrode 14 is shown disposed at or proximate to the first portion 27, and is spaced a distance from the metal electrode 12. The holes 26 provide for interaction between the air electrode 14 and the oxygen in the surrounding atmosphere (e.g., air). The surrounding atmosphere may be ambient air or one or more air flows may be directed into or across the holes 26. The housing may have any number of shapes and/or configurations according to other exemplary embodiments. Any number of holes having any of a variety of shapes, sizes, and/or configurations may be utilized according to other exemplary embodiments.

The air electrode 14 includes one or more layers with different properties and a current collector (e.g., a metal mesh, which also helps to stabilize the air electrode). In some exemplary embodiments, a plurality of air electrodes may be used for a single battery. In some of these exemplary embodiments, at least two of the air electrodes have different layering schemes and/or compositions. In other exemplary embodiments, the current collector is other than a metal mesh current collector (e.g., a foam current collector).

Referring further to FIG. 2, the air electrode 14 includes a gas diffusion layer 30 (sometimes abbreviated “GDL”) and an active layer 32 (sometimes abbreviated “AL”) according to an exemplary embodiment.

The gas diffusion layer 30 is shown disposed proximate to the holes 26 in the second portion 28 of the housing 22, substantially between the active layer 32 and the housing 22. The gas diffusion layer 30 includes a plurality of pores 33 according to an exemplary embodiment. The gas diffusion layer 30 is configured to be porous and hydrophobic, allowing gas to flow through the pores while acting as a barrier to prevent liquid flow. In some exemplary embodiments, both the oxygen reduction and evolution reactions take place in one or more air electrode layers closely bonded to this layer.

The active layer 32 is disposed substantially between the metal electrode 12 and the holes 26 in the second portion 28 of the housing 22 according to an exemplary embodiment. The active layer 32 has a double pore structure that includes both hydrophobic pores 34 and hydrophilic pores 36. The hydrophobic pores help achieve high rates of oxygen diffusion, while the hydrophilic pores 36 allow for sufficient electrolyte penetration into the reaction zone for the oxygen reaction (e.g., by capillary forces). According to other exemplary embodiments, the hydrophilic pores may be disposed in a layer separate from the active layer, e.g., an oxygen evolution layer (sometimes abbreviated “OEL”). Further, other layers or materials may be included in/on or coupled to the air electrode. For example, gas selective materials may be included in the pore structure.

The air electrode 14 may include a combination of pore forming materials. In some exemplary embodiments, the hydrophilic pores of the air electrode are configured to provide a support material for a catalyst or a combination of catalysts (e.g., by helping anchor the catalyst to the reaction site material) (e.g., cobalt on carbon, silver on carbon, etc.). According to one exemplary embodiment, the pore forming material includes activated carbon or graphite (e.g., having a BET surface area of more than 100 m²·g⁻¹). According to other exemplary embodiments, pore forming materials such as high surface area ceramics or other materials may be used. More generally, using support materials (or pore forming materials) that are not carbon-based avoids CO₂ formation by those support materials when charging at high voltages (e.g., greater than 2V). One example is the use of high surface area silver (Ag); the silver can be Raney Ag, where the high surface area is obtained by leaching out alloying element from a silver alloy (e.g., Ag—Zn alloy). According to still other exemplary embodiments, any material that is stable in alkaline solutions, that is conductive, and that can form a pore structure configured to allow for electrolyte and oxygen penetration, may be used as the pore forming material for the air electrode. According to an exemplary embodiment, the air electrode internal structures may be used to manage humidity and CO₂.

Referring further to FIG. 2, a current collector 39 is disposed between the gas diffusion layer 30 and the active layer 32 of the air electrode 14 according to an exemplary embodiment. According to another exemplary embodiment, the current collector may be disposed on the active layer (e.g., when a non-conductive layer or no gas diffusion layer is included in the air electrode). The current collector 39 may be formed of any suitable electrically-conductive material.

The air electrode 14 further includes a binding agent or combination of binding agents 40, a catalyst or a combination of catalysts 42, and/or other additives (e.g., ceramic materials, high surface area metals or alloys stable in alkaline media, etc.). According to an exemplary embodiment, the binding agents 40 are included in both the active layer 32 and the gas diffusion layer 30, and the catalysts 42 are included in the active layer. According to other exemplary embodiments, the binding agents, catalysts, and/or other additives may be included in any, none, or all of the layers of the air electrode. In other exemplary embodiments, the air electrode may not contain one or more of a binding agent or combinations of binding agents, a catalyst or a combination of catalysts, and/or other additives.

The binding agents 40 are intended to bind the components of the air electrode together while still allowing the air electrode to have relatively high oxygen diffusion rates. The binding agents 40 may also cause pores in the air electrode 14 to become hydrophobic to limit the amount of liquid transport through the air electrode.

The binding agents 40 may include, for example, polymeric materials such as polytetrafluoroethylene (PTFE), polyethylene (PE), polypropylene (PP), polyisobutylene (PIB), thermoplastics such as polybutylene terephthalate (PBT) or polyamides, polyvinylidene fluoride (PVDF), silicone-based elastomers such as polydimethyl siloxane (PDMS) or rubber materials such as natural rubber (NR), ethylene propylene rubber (EPM) or ethylene propylene diene monomer rubber (EPDM), or combinations thereof.

According to an exemplary embodiment, binding agents such as PP and/or PE may be used as the only binders in a particular layer (replacing, for example, PTFE). According to other exemplary embodiments, binding agents such as PP and/or PE may be used in combination with PTFE in a particular layer to allow the benefits of PTFE (which provides, for example, excellent oxygen transport) to be balanced with the benefits of PP and/or PE (which, as described below, act to increase the mechanical strength of the air electrode).

The binding agents 40 are intended to provide increased mechanical strength for the air electrode 14, while providing for maintenance of relatively high diffusion rates of oxygen (e.g., comparable to more traditional air electrodes that typically use polytetrafluoroethylene (“PTFE”)). The binding agents 40 may also cause pores in the air electrode 14 to become hydrophobic. According to one exemplary embodiment, the binders include PTFE in combination with other binders. According to other exemplary embodiments, other polymeric materials may also be used (e.g., thermoplastics such as polybutylene terephthalate or polyamides, polyvinylidene fluoride, silicone-based elastomers such as polydimethylsiloxane, or rubber materials such as ethylene propylene, and/or combinations thereof).

According to an exemplary embodiment, the binding agents 40 provide mechanical strength sufficient to allow the air electrode 14 to be formed in a number of manners, including, but not limited to, one or a combination of injection molding, extrusion (e.g., screw extrusion, slot die extrusion, etc.), stamping, pressing, utilizing hot plates, calendering, etc. This improved mechanical strength also enables air electrode 14 to be formed into any of a variety of shapes (e.g., a tubular shape, etc.). The ability to form the air electrode into any of a variety of shapes may assist in the manufacture of metal-air batteries for applications such as Bluetooth headsets, applications for which tubular batteries are used or required (e.g., size AA batteries, size AAA batteries, size D batteries), etc.

In an exemplary embodiment, the battery 10 is a secondary battery (e.g., rechargeable) and the air electrode 14 is a bifunctional air electrode. According to other exemplary embodiments, the battery 10 may be a primary battery (e.g., single use, disposable, etc.).

The catalysts 42 are configured to improve the reaction rate of the oxygen reactions within the battery, including the oxygen reduction and evolution reactions. According to some exemplary embodiments, catalytically active metals or oxygen-containing metal salts are used (e.g., Pt, Pd, Ag, Co, Fe, MnO₂, KMnO₄, MnSO₄, SnO₂, Fe₂O₃, CoO, CO₃O₄, etc.). According to other exemplary embodiments, catalysts may include, but are not limited to, WC, TiC, CoWO₄, FeWO₄, NiS, WS₂, La₂O₃, Ag₂O, Ag, spinels (i.e., a group of oxides of general formula AB₂O₄, where A represents a divalent metal ion such as magnesium, iron, nickel, manganese and/or zinc and B represents trivalent metal ions such as aluminum, iron, chromium and/or manganese) and perovskites (i.e., a group of oxides of general formula AXO₃, where A is a divalent metal ion such as cerium, calcium, sodium, strontium, lead and/or various rare earth metals, and X is a tetrahedral metal ion such as titanium, niobium and/or iron where all members of this group have the same basic structure with the XO₃ atoms forming a framework of interconnected octahedrons). According to other exemplary embodiments, a combination of more than one of the foregoing materials may be used.

According to an exemplary embodiment, the air electrode 14 is formed in a three-step process. Each layer of the multi-layer air electrode 14 is formed separately. First, the desired component elements of each layer are mixed together. The pore forming materials, the catalysts, the binding materials and/or other additives are mixed under the influence of mechanical, thermal, or mechanical and thermal energy. In this process it is desirable that the materials be well distributed. If the mixture contains a hydrophobic binding agent, then this binding agent forms a three dimensional network connecting the powders into an agglomerate. The mixture or the agglomerate is then typically extruded and/or calendered into a layer. Secondly, one or more layers, typically having differing properties (e.g., the gas diffusion layer and the active layer), are combined using heat and/or pressure (e.g., by calendering and/or pressing). Third, the current collector is pressed or calendered into the combined layers (e.g., into the active layer, into the gas diffusion layer, between the active layer and the gas diffusion layer, etc.). According to other embodiments, however, the air electrode may be formed using other processes.

According to an exemplary embodiment, a dry mixing process is utilized in the first step to form the layers of air electrode 14. In a dry mixing process, all of the ingredients of a layer are mixed together in the form of dry powders. According to an exemplary embodiment, a dry process utilizes PTFE binders having a particle size below 1 mm as a binder. In a case where carbon itself does not form the pore structure, an additional pore forming aid such as ammonium bicarbonate may be used to create the gas diffusion layer and/or the oxygen evolution layer.

According to other exemplary embodiments, a wet mixing process may instead be utilized. In a wet mixing process, one or more solvents are added at the beginning or during the mixing process, or, alternatively, one or more ingredients may be used in the form of a dispersion or suspension. The solvent(s) are typically subsequently removed (e.g., directly after the mixing process or in a later state of the production process) (e.g., by using a heating/drying process). According to an exemplary embodiment, a wet process utilizes PTFE that is suspended in water as a binder and a pore forming aid or a carbon material in the gas diffusion layer is used to form pores.

According to still another exemplary embodiment, the various individual layers may be made using different methods. For example, some of the layers may be produced using a dry mixing process, while others may be produced using a wet process. According to yet still another exemplary embodiment, it is possible to combine both dry and wet processes for the different layers and the production may be performed in a continuous production line according to PCT publication WO 2005/004260, the disclosure of which is incorporated herein by reference.

An oxygen evolution layer may be included in the air electrode. According to an exemplary embodiment, the oxygen evolution layer may include 2 to 15 percent binding agent by weight and 25 to 65 percent catalyst(s) by weight. The remainder of the oxygen evolution layer may include a high surface area carbon and/or graphite material and possibly some other additives.

An exemplary embodiment of an air electrode formation method utilizing a dry mixing process will now be discussed. According to this method, the active layer is prepared using a mixture of 15 percent PTFE by weight (e.g., in powder form with a particle size below 1 mm from Lawrence Industries of Thomasville, N.C. as a binding agent), 70 percent high surface area carbon (e.g., XC 500 from Cabot) by weight as a pore forming agent, and 15 percent manganese sulfate (e.g., MnSO₄ from Prolabo of France) by weight as a catalyst. The binding agent, the pore forming agent, and the catalyst are mixed together (e.g., in a single-shaft rotary mixer at approximately 1,000 rpm) to form a substantially homogeneous mixture. The mixture is heated to a desired temperature. When the powder mixture reaches the desired temperature, the powder is milled to form an agglomerate. For example, the mixture may be heated to a desired temperature at or near 90° C. and milled at approximately 1,000 rpm for 1 hour, or the mixture may be heated to a lower initial temperature, but milled at a higher rpm (e.g., 10,000 rpm). The agglomerate is pressed into a brick (e.g., a brick of about 2 mm thickness) and then calendered into a sheet (e.g., of about 0.5 mm thickness). According to other exemplary embodiments, the temperatures, milling rates and times, and other parameters may vary depending on the particular materials used and other factors.

The gas diffusion layer is formed using a mixture of 25 percent PTFE by weight (e.g., in powder form with a particle size below 1 mm from Lawrence Industries of Thomasville, N.C.) as a binding agent and 75 percent ammonium bicarbonate by weight (e.g., with a particle size below 10 μm from Sigma-Aldrich, Inc.) as a pore forming agent. The binding agent and the pore forming agent are mixed at a desired temperature (e.g., typically below a maximum temperature of 40° C.) in a single-shaft rotary mixer (e.g., for 2 hours at 1,500 rpm) to form an agglomerate. The agglomerate is pressed into a brick (e.g., of about 2 mm thickness) and then calendered into a sheet (e.g., of about 1 mm thickness).

An exemplary embodiment of an air electrode formation method utilizing a wet mixing process will now be discussed. According to this method, the active layer is prepared using 15 percent PTFE by weight in a suspension containing 60 percent PTFE by weight dispersed in water (e.g., from Sigma-Aldrich, Inc.) as a binding agent, 65 percent high surface area carbon (e.g., XC 500 from Cabot) by weight as a pore forming agent, and 20 percent manganese sulfate (e.g., MnSO₄ from Prolabo of France) by weight as catalysts. The high surface area carbon is mixed with both catalysts in water. Separately, the PTFE suspension is mixed with water. The PTFE suspension is then added to the carbon suspension and mixed to form a slurry agglomerate. The slurry is then mixed (e.g., in an ultrasonic bath for 30 minutes) and subsequently dried (e.g., at 300° C. for 3 hours) to remove any surfactants. The dried mixture is then agglomerated and a hydrogen treated naphtha with a low boiling point (e.g., Shellsol D40 from Shell Chemicals of London) is added to form a paste. Finally, the paste is calendered into a thin layer to form the active layer.

The hydrophobic gas diffusion layer may be formed by the same method according to an exemplary embodiment. In this layer only high surface area carbon (65 percent by weight) and PTFE (35 percent by weight) are used. The final layer is relatively thin (e.g., having a thickness of about 0.8 mm).

The active layer and the gas diffusion layer are then coupled (e.g., by calendering) to form the air electrode (e.g., having a total thickness of 0.8 mm). Finally, a current collector (e.g., nickel mesh) is pressed into the air electrode (e.g., at 70 bars and at a temperature of between approximately 80° C. and 320° C., and preferably approximately 300° C.) between the active layer and the gas diffusion layer. The air electrode may then be dried (e.g., at 70° C. for 8 hours) to create the hydrophobic porosity of the gas diffusion layer.

According to other exemplary methods of forming and constructing an air electrode and the layers thereof, the layers may be formed to have a variety of thickness and/or compositions. Further, the layers may be coupled by any of a number of methods known in the art.

Referring to FIG. 2A, according to an exemplary embodiment, a membrane shown as a siloxane membrane 16A (e.g., film, layer, etc.) may optionally be disposed adjacent to the air electrode 14A (i.e., located substantially adjacent to the gas diffusion layer 30A of the air electrode 14A between the gas diffusion layer 30A and the holes 26A in the housing 22A). The siloxane membrane is 16A is a selective membrane that allows gases such as oxygen to pass through the membrane while acting as a moisture barrier to prevent moisture from entering and exiting the battery. This in turn helps to maintain the water balance within the battery 10. The siloxane membrane may be produced using any suitable method, as described more fully in U.S. patent application Ser. No. 12/828,016, filed Jun. 30, 2010, the disclosure of which is incorporated herein by reference.

The siloxane membrane 16A is configured to improve the performance and usable lifetime of the battery 10A by preventing or slowing down the drying out of the electrolyte and the flooding of the air electrode. The siloxane membrane 16A is configured to prevent water from the electrolyte 18A from leaving the battery 10A (e.g., when the relative humidity less than 45 percent relative humidity or some other relative humidity that would result in water loss), thus helping to avoid the loss in the power density and efficiency of the battery that occurs when electrolyte dries out. The siloxane membrane 16A is also configured to prevent flooding of the battery 10A (e.g., when the relative humidity is greater than 45 percent or some other relative humidity that would result in flooding), helping to prevent the electrolyte 18A from leaking therefrom (when the electrolyte leaks from the battery, the electrolyte concentration (the ratio between electrolyte and Zn) falls, resulting in significant decreases in the discharge performance and the ability to store metal-air batteries long-term. In this manner, the siloxane membrane 16A helps stabilize, improve the performance of, and prolong the lifetime of the battery 10A, significantly expanding the potential commercial uses of metal-air batteries.

The siloxane membrane 16A is also configured to prevent ingress of CO₂ through the holes 26A in the housing. It is known that CO₂ consumes OH⁻ ions in electrolyte, increases the evaporation of water, and forms non-hygroscopic crystals. By preventing CO₂ from entering the housing 22A, the siloxane membrane 16A helps preserve the electrolyte 18A and maintain the water balance within the battery 10A.

The siloxane membrane 16A has a thickness of between approximately 0.1 μm and 200 μm (although the thickness may be greater according to other exemplary embodiments, for example, the thickness of the membrane may be between 1 and 50 μm, less than or equal to 10 μm, less than or equal to 6 μm, less than or equal to 3 μm, or any other suitable thickness as may be appropriate under the circumstances), and has suitable mechanical strength to allow its production using a wide range of manufacturing methods. The greater the thickness of the siloxane membrane, the better it will be expected to perform in preventing CO₂ and water vapor from being transported into and/or out of battery 10A (e.g., because of the longer diffusion path). The thickness of siloxane membrane 16A may be varied depending on the intended application for the battery, since the thickness of an applied membrane/film is expected to be directly proportional to the current density that can be achieved for a battery. For example, for applications using a relatively low current density (e.g., lower power applications such as batteries for watches, sensors, RFID tags, etc.), films with relatively greater thicknesses may be used (e.g., a 100 μm film that provides a maximum current density of 2 mA/cm²). In other applications where high current density is required (e.g., high power applications such as cameras, blue tooth applications, cellular phones, etc.), it may be desirable to use a siloxane film of lesser thickness (e.g., a 3 μm film that can provide a maximum current density of more than 50 mA/cm² at above 1 V).

Different applications have different current density needs, and, accordingly, the thickness of the selective membrane may be tailored to achieve a desired current density. According to other exemplary embodiments, any selective membrane material having a thickness/diffusion coefficient combination sufficient to both stabilize a metal-air battery while maintaining a desired performance level may be utilized.

According to an exemplary embodiment, increasing the surface area of the air electrode may allow for the use of thicker siloxane films that still allow the battery to achieve a desired current density. Generally, a larger surface area allows for a higher reaction rate, since the current density (mA/cm²) is determined by the thickness of the siloxane film, while the current (mA) is determined by the current density and the surface area of the air electrode available for the application. These considerations may be balanced by a battery designer attempting to achieve a certain level of battery performance while taking advantage of the enhancements that the use of a selective siloxane membrane can provide for the battery.

The siloxane membrane 16A also allows for the use of larger and/or more holes 26A in the housing 22A for oxygen access than would otherwise be possible (e.g., more air may be allowed to enter the battery when the siloxane membrane 16A is used because of its beneficial protections against dry out and flooding). This allows the battery 10A to operate at higher currents without oxygen diffusion limitations and increased dry out rates. As an example, a primary coin cell (e.g., size 675) zinc-air battery may show diffusion limitation at about 30 mA due to the limited oxygen access. Providing a hole of more than 5 mm in diameter gives a pulse current of more than 100 mA without diffusion limitations. Further, this enables greater flexibility in the design of housing 22A (e.g., casing, containers, etc.) and better uniformity of the oxygen distribution (with even partial pressure of O₂ over the whole surface, the reaction rate is equal, and a more uniform reaction gives better stability for the Zn and air electrode). By allowing for larger and/or more holes in the housing, the current density of the battery is not limited by the access of oxygen through the holes, but, rather, by the transport of oxygen through the selective membrane. With the selective membranes having high transport properties for oxygen, this also opens the possibility to use metal-air batteries for higher power applications (e.g., laptops, cars, etc.).

According to an exemplary embodiment, the siloxane membrane 16A does not include a support layer (e.g., a finely porous film, a non-woven fabric, etc.), because the thickness of the siloxane membrane 16A itself provides sufficient stability and structural integrity for the given application. This also provides for improved handling during manufacture of the batteries and resistance against the formation of pin holes. For thinner siloxane membranes (e.g., membranes having a thickness below approximately 20 μm), there may be some advantage to using a support layer.

The improved mechanical strength of the siloxane membrane also provides for a wide range of formation and application methods. The siloxane membrane formation process may include stamping, pressing, and/or other processes or combinations of processes that would not be able to be utilized or be utilized as well with thinner and/or weaker films or membranes, as will be discussed in more detail below. Further, the improved formation and applications methods enable the battery 10A to be used in a wider range of applications.

According to an exemplary embodiment, the siloxane membrane 16A is formed using siloxane Geniomer® 80 from Wacker Chemie AG of Munich, Germany. Geniomer® 80 is a reaction product of silicone resin with silicone fluids, which forms water-repellent release films. These films have much better affinity than is attainable with polydimethylsiloxanes and many organomodified silicone fluids of comparable viscosity. For Geniomer® 80, the oxygen diffusion coefficient for a 10 μm thick film is approximately 6.2E-11 m²/s. According to other exemplary embodiments, other siloxane materials may be used (e.g., siloxane from Folex Imaging, Celfa AG, CM Celfa Membranes, etc.). For example, the oxygen diffusion coefficient for a 20 μm thick film made with the siloxane from Celfa is approximately 5.7E-11 m²/s.

Although one particular embodiment of a battery using a siloxane membrane has been described thus far, according to other exemplary embodiments, modifications may be made to the composition and/or positioning of the siloxane membrane. For example, according to one exemplary embodiment, the siloxane membrane may be made conductive for use on top of the gas diffusion layer. According to one exemplary embodiment, materials (e.g., in the form of particles) may be added to the siloxane membrane to enable the siloxane membrane to function as the current collector for the battery cathode. Exemplary materials include, but are not limited to, carbon (e.g., graphite) particles and metallic particles. According to an exemplary embodiment, a siloxane membrane may be made conductive by dip coating the gas diffusion layer into a siloxane solution. A siloxane film is then created within the pore structure of the gas diffusion layer at the same time as the conductive support material (carbon) allows for electronic contact with the current collector.

According to another exemplary embodiment, the siloxane membrane may be positioned outside of the housing instead of within the housing as shown in FIG. 2A (e.g., it may be positioned outside of the housing 22A positioned substantially over the holes 26A that are included in the housing 22A. This configuration may be particularly desirable, for example, if the battery 10A is placed in a housing that has a larger surface area than the battery case. According to another exemplary embodiment, a porous support material (e.g., made of a polymer such as PTFE) may be coated with siloxane (which may fill in some of the pores of the support material) and positioned over the holes. According to some exemplary embodiments, a porous support material including a siloxane additive may be positioned over the holes. It should be noted that, when the siloxane membrane is disposed outside of the housing, the conductivity of the siloxane membrane is substantially irrelevant because there is substantially no need to transport electrons.

According to another exemplary embodiment, the siloxane membrane may be integrated with the housing. For example, a battery having a housing in the form of a soft pouch could incorporate siloxane into the pouch material. In another exemplary embodiment, the siloxane membrane may be provided proximate to or within the air electrode.

According to another exemplary embodiment, the siloxane membrane may take the place of or act as the gas diffusion layer. For example, a siloxane layer may be disposed adjacent to an active layer in the air electrode. This configuration provides a number of advantages, including, but not limited to, providing enhanced long lifetime stability and safety against leakage because the siloxane layer is substantially a solid membrane that will not allow liquid penetration and is also selective to oxygen to prevent CO₂ from entering the cell. According to another exemplary embodiment, siloxane may be mixed with the materials of the gas diffusion layer to form a single conductive siloxane membrane layer.

According to an exemplary embodiment, multiple metal electrodes and air electrodes may be provided in a single metal-air battery. Further, while the siloxane membrane and the air electrode are discussed independently for the purposes of this disclosure, it should be recognized that the siloxane membrane may be considered to be a layer of the air electrode.

According to an exemplary embodiment, the siloxane membrane 16A may be used in combination with additional layers (e.g., one or more layers of porous plastic materials, one or more metal layers, etc.) to achieve a desired selectivity for oxygen, water vapor management, and carbon-dioxide management for battery 10A. For example, by forming thin (submicron to nanometer) solid nonporous silver layers on the siloxane (e.g., using vapor deposition or similar techniques), the selectivity for O₂ transport while preventing water vapor and CO₂ passage may be improved. Since the rate of transport of oxygen is slow through silver, this additional layer needs to be very thin and will therefore require a support material for deposition. Siloxane can act as this support material, and also advantageously has high oxygen transport properties.

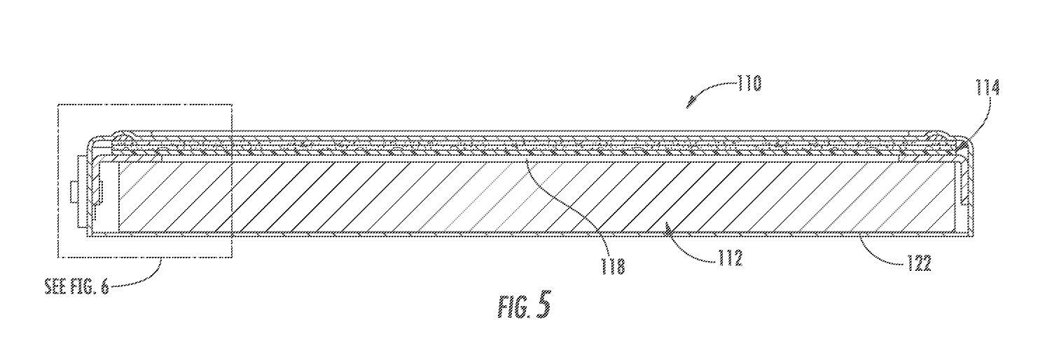

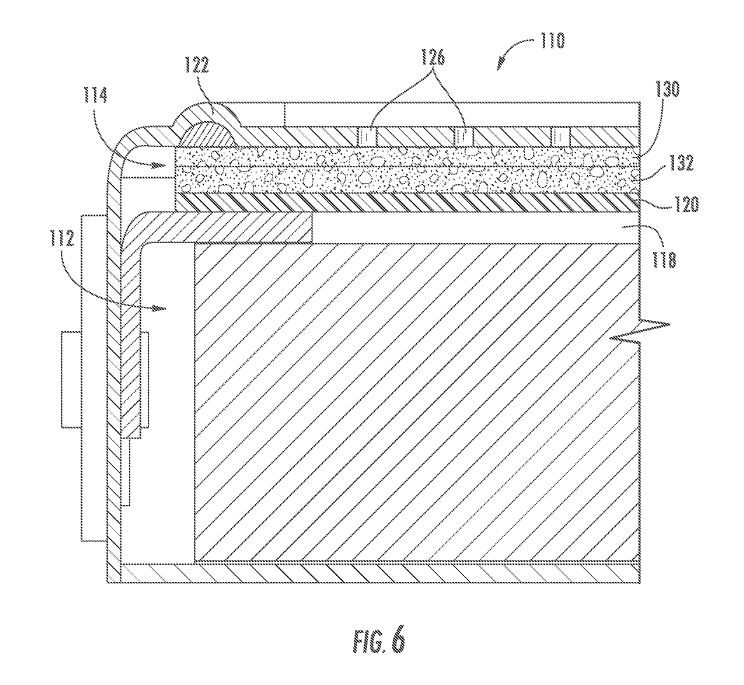

Although FIGS. 1, 2, and 2A illustrate a battery in the form of a coin or button cell, it should be noted that other configurations are also possible. For example, referring to FIGS. 4-6, a prismatic metal-air (e.g., zinc-air) battery 110 is shown according to an exemplary embodiment. FIG. 5 shows a cross-sectional view of the battery 110, and FIG. 6 shows a detail view of one end of the battery 110 taken across line 6-6 in FIG. 5. The battery 110 includes a housing 122, a metal electrode 112 running along the length of the cell, an air electrode 114, and an electrolyte 118 provided in the space between the metal electrode 112 and the air electrode 114. A separator layer 120 may also be provided that is similar to that described with respect to separator layer 120 (which will be described in more detail below). The electrolyte 118 also resides inside the pores of the metal electrode 112 and partly inside the pores of the air electrode 114. A siloxane membrane (similar to that described with respect to the siloxane membrane 16A for the coin cell embodiment described above) may optionally be provided on top of/adjacent to the air electrode 114. The upper portion of the housing 122 contains holes 126 (e.g., slots, apertures, etc.) for air to enter the battery 110.

The air electrode 114 (and optional siloxane membrane) may be secured (e.g., by gluing) to the lid of the housing to prevent leakage. The gas diffusion layer side of the air electrode faces the holes 126 in the battery housing 122, and the siloxane membrane 116 is positioned substantially between the gas diffusion layer and the holes 126 in the housing 122. The battery 110 is filled with a metal (e.g., zinc) paste. Current collectors for the air electrode and the metal electrode may be attached using contact pins by resistance welding, laser welding, or other methods known in the art and shielded (e.g., with glue) to prevent gassing in the cell. The housing is then closed off (other than the air holes) (e.g., by ultrasonic welding).

The battery 110 provides for a commercially viable prismatic battery that may be used in numerous applications wherein prismatic batteries are or may be used because battery 110 provides, in addition to a high current density, a lifetime in that is sufficient and/or desirable for these applications (e.g., cell phones, cameras, MP3 players, portable electronic devices, etc.).

FIG. 7 illustrates an exemplary embodiment of a flow battery 210 similar to those disclosed in International Application PCT/US10/40445 and corresponding U.S. patent application Ser. No. 12/826,383, each filed Jun. 29, 2010, the entire disclosures of which are incorporated herein by reference.

Referring to FIG. 7, a metal-air flow battery shown as a zinc-air flow battery 210 is shown according to an exemplary embodiment. The term “flow battery” is intended to refer to a battery system in which reactants are transported into and out of the battery. For a metal-air flow battery system, this implies that the metal anode material and the electrolyte are introduced (e.g., pumped) into the battery and a metal oxide is removed from or taken out of the battery system. Like a fuel cell, the flow battery system requires a flow of reactants through the system during use.

The zinc-air flow battery 210 is shown as a closed loop system including a zinc electrode 212, an electrolyte 218, one or more storage devices shown as tank or chamber 244, and a reactor 246 having one or more reaction tubes 248, each including an air electrode 214. A separator layer 220 may also be provided that is similar to that described with respect to separator layer 220 (which will be described in more detail below).

The zinc electrode 212 is combined with the electrolyte 218 to form a zinc paste 250, which serves as a reactant for the zinc-air flow battery 210 according to an exemplary embodiment. The reactant (e.g., active material, etc.) is configured to be transported (e.g., fed, pumped, pushed, forced, etc.) into and out of the reactor 246. When the zinc-air flow battery 210 is discharging, the zinc paste 250 is transported into the reactor 246 and through the reaction tubes 248 and a zinc oxide paste 252 is transported out of the reactor 246 after the zinc paste 250 reacts with the hydroxyl ions produced when the air electrode 214 reacts with oxygen from the air. When the zinc-air flow battery 210 is charging, the zinc oxide paste 252 is transported into the reactor 246 and through the reaction tubes 248 and the zinc paste 250 is transported out of the reactor 246 after the hydroxyl ions are converted back to oxygen. The pastes 250, 252 are stored in the tank 244 before and after being transported through the reactor 246, the zinc paste 250 being stored in a first cavity 254 of the tank 244 and the zinc oxide paste 252 being stored in a second cavity 256 of the tank 244. According to another exemplary embodiment, the tank 244 includes only a single cavity, and the zinc oxide paste is stored in the single cavity.

As discussed above, the reaction tubes 246 each include an air electrode 214 disposed between at least two protective layers. FIG. 7 illustrates one of the reaction tubes 248 of the zinc-air flow battery 210 in more detail, exploded from the zinc-air flow battery 210 according to an exemplary embodiment. The reaction tube 248 is shown having a layered configuration that includes an inner tube or base 258, a separator 260, the air electrode 214, and an outer tube or protective casing 262 according to an exemplary embodiment. The base 258 is shown as the innermost layer of the reaction tube 246, the protective casing 262 is shown as the outmost layer of the reaction tube 246, and the other layers are shown disposed substantially between and concentric with the base 258 and the protective casing 262.

According to the exemplary embodiment shown, the composition of air electrodes 214 enables production of tubular air electrodes according to an exemplary embodiment. The air electrode 214 includes a plurality of binders 264. The binders 264 provide for increased mechanical strength of the air electrode 214, while providing for maintenance of relatively high diffusion rates of oxygen (e.g., comparable to more traditional air electrodes). The binders 264 may provide sufficient mechanical strength to enable the air electrode 214 to be formed in a number of manners, including, but not limited to, one or a combination of injection molding, extrusion (e.g., screw extrusion, slot die extrusion, etc.), stamping, pressing, utilizing hot plates, calendaring, etc. This improved mechanical strength may also enable air electrode 214 to be formed into any of a variety of shapes (e.g., tubular, etc.).

The tubular configuration of the reaction tubes 246, and, correspondingly, the air electrodes 214, makes the air electrodes 214 relatively easy to assemble without leakage. The tubular configuration in conjunction with the conductive gas diffusion layer permits for the current collectors for the air electrodes 214 to be on the outside of the reaction tubes 246, substantially preventing any leakage from the air electrode current collector. Further, the tubular configuration permits for the current collectors for zinc electrodes 212 to be integrated substantially within reaction tubes 246, eliminating contact pin leakage.

In addition, the tubular configuration of air electrodes a 214 provides improved resistance to pressure, erosion (e.g., during transport of zinc paste 250 and zinc oxide paste 252, etc.), and flooding. For example, the tubular configuration of the air electrode permits zinc paste to flow through a passage 260 defined thereby with less friction than if the air electrode were configured as a flat plate, causing relatively less erosion therewithin. Also, the cylindrical reaction tubes 246 having a layered configuration permits for incorporation of elements/layers providing mechanical stability and helping to provide improved pressure resistance.

The optional siloxane membrane (not shown) may be disposed to the exterior of a gas diffusion layer 230 and active layer 232 of the air electrode 214 in the reaction tube 246 according to an exemplary embodiment. By including a siloxane membrane in the zinc-air flow battery 210, less electrolyte 218 is needed in the tank 222 to accommodate the water loss attendant with its operation (e.g., as a result of vaporization, etc.). Further, by reducing the negative effects of CO₂ on the zinc-air flow battery 210, the siloxane membrane reduces the need for peripherals and maintenance (e.g., CO₂ scrubbers, etc.). According to other exemplary embodiments, the air electrode and the siloxane membrane may be otherwise configured. For example, the siloxane membrane may replace the gas diffusion layer or be positioned exterior to the protective casing 262. According to still other exemplary embodiments, siloxane may be incorporated into the reaction tube other than in the form of a membrane. For example, siloxane material may be incorporated into one or more layers of the air electrode.

During discharge of the zinc-air flow battery 210, the zinc paste 250 is fed from the tank 244 through a zinc inlet/outlet and distributed amongst the reaction tubes 246 by a feed system 272. According to the exemplary embodiment shown, the feed system 272 includes a plurality of archimedean screws 274. The screws 274 rotate in a first direction, transporting the zinc paste 250 from proximate the first end portion 276 toward the second end portion 278 of each reaction tube 246. An air flow 280 is directed by an air flow system 282, shown including fans 284, through a plurality of air flow channels 286 defined between the reaction tubes 246. The air flow 280 is at least partially received in the reaction tubes 246 through a plurality of openings 288 in the protective casing 262 and toward the passage 266, as shown by a plurality of air flow paths 290. Oxygen from the air flow 280 is converted to hydroxyl ions in the air electrode 214; this reaction generally involves a reduction of oxygen and consumption of electrons to produce the hydroxyl ions. The hydroxyl ions then migrate toward the zinc electrode 212 in the zinc paste 250 within the passages 266 of the reaction tubes 246. The hydroxyl ions cause the zinc to oxidize, liberating electrons and providing power.

As a result of its interaction with the hydroxyl ions, the zinc paste 250 is converted to the zinc oxide paste 252 within the reaction tubes 246 and releases electrons. As the screws 274 continue to rotate in the first direction, the zinc oxide paste 252 continues to be transported toward the second end portion 278. The zinc oxide paste 252 is eventually transported from reaction tubes 246 through a zinc oxide inlet/outlet and deposited in the second cavity 256 of the tank 244. According to another exemplary embodiment, the tank 244 includes only a single cavity, and the zinc oxide paste is stored in the single cavity.

As discussed above, the zinc-air flow battery 210 is rechargeable. During charging, the zinc oxide paste 252 is converted or regenerated back to zinc paste 250. The zinc oxide paste 252 is fed from the tank 244 and distributed amongst the reaction tubes 246 by the feed system 272. The screws 274 rotate in the second direction (i.e., opposite to the direction they rotate during discharging), transporting the zinc oxide paste 252 from proximate the second end portion 278 toward the first end portion 276 of each reaction tube 246. The zinc oxide paste 252 is reduced to form the zinc paste 250 as electrons are consumed and stored. Hydroxyl ions are converted to oxygen in the air electrodes 214, adding oxygen to the air flow 280. This oxygen flows from the reaction tubes 246 through the openings 288 in the protective casing 262 outward from proximate the passage 266, as shown by the air flow paths 290.

Conventional metal-air batteries are limited by environmental conditions (e.g., the presence of CO₂, humidity, etc.), which limit the battery life and performance (e.g., standby lifetime). Metal-air coin or button cells are currently the only metal-air batteries that are commercially available/utilized in a large volumes. Most commonly, these metal-air batteries are used in hearing aids. These batteries have a relatively long shelf life due to closed air access packaging, but dry out within relatively quickly (e.g., approximately within five weeks of removing the tape covering the holes in the housing of the metal-air coin cell) because, when in use, the surrounding environmental conditions cause a slow capacity loss of the metal-air coin cell batteries. Due to these constraints, only a small part of the coin cell size battery market is available for these batteries. For the existing coin metal-air batteries, current densities of up to 20-25 mA and cut off voltages of 1-1.1V for 675 size metal-air coin cell are typically sufficient for the hearing aid. Also, an energy density of 1400 Wh/l can be shown for existing coin metal-air batteries. Coin cells for other electronic devices are based on Ag/Zn, MnO₂/Zn, or lithium cannot match the energy density of metal-air (e.g., zinc-air) batteries.

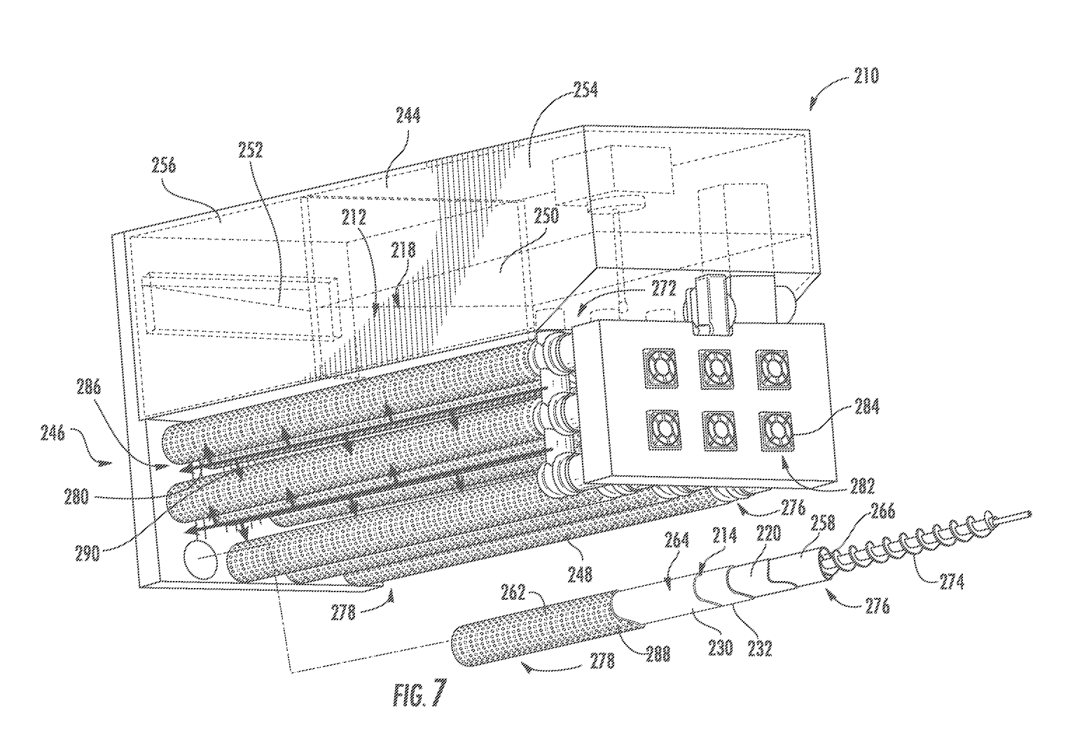

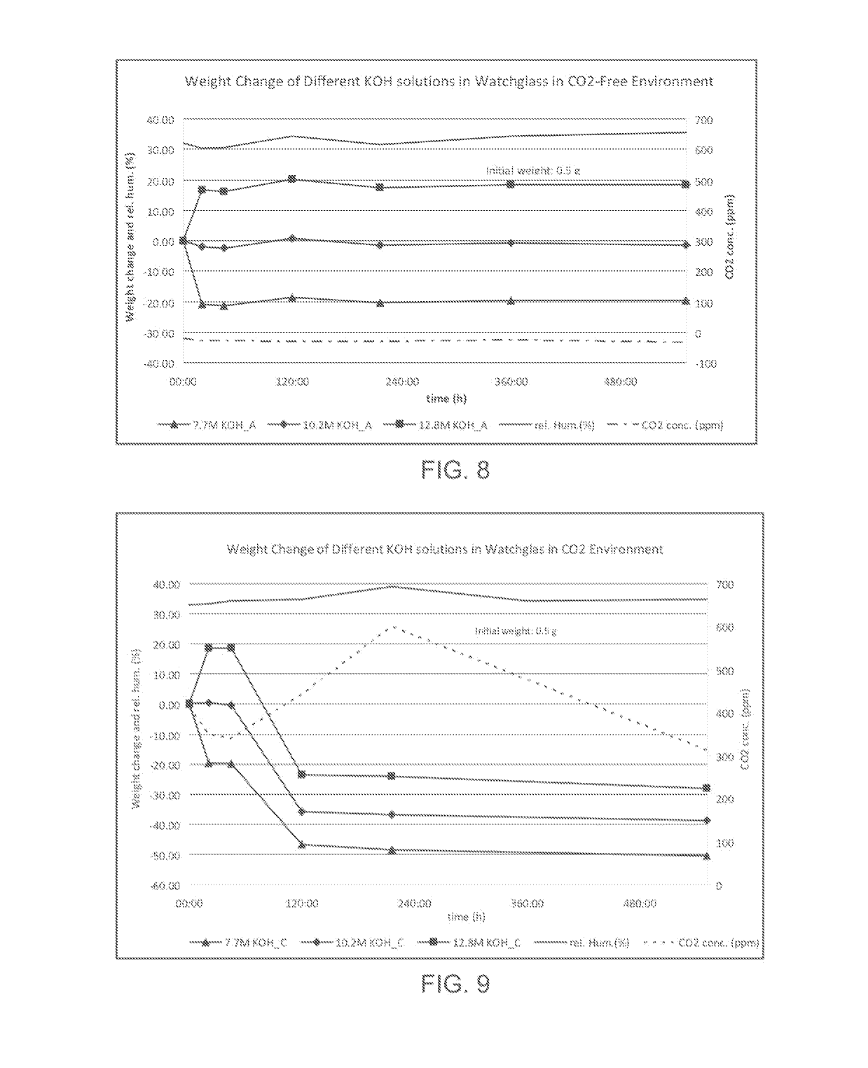

The impact of humidity and exposure to CO₂ will now be discussed in more detail with reference to FIGS. 8-13.

It is known that potassium hydroxide (KOH), which is one possible material used for the metal-air battery electrolyte, is hygroscopic. Theoretically, KOH should not dry out above a certain relative humidity. FIGS. 8 and 9 illustrate the effects of CO₂ absorption on the percentage weight change of a KOH electrolyte over time in an environment having approximately 35 percent relative humidity. Various KOH/water solutions (7.7M, 10.2M, and 12.8M) were provided in a watchglass in a CO₂-free environment (FIG. 8) and in a CO₂-containing environment (FIG. 9), and the percentage weight change of the electrolyte over time was monitored. As can be seen in FIG. 8, in the CO₂-free environment, the various KOH solutions first adjusted to the relative humidity of the surroundings by taking up or losing water, according to their concentration, and then their weight remained substantially constant/stable thereafter (the weight of the 12 M KOH solution did not initially adjust to a significant degree because it was already in equilibrium with the relative humidity of 35 percent). In contrast, as shown in FIG. 9, where the KOH solutions were provided in a CO₂-containing environment, these KOH solutions continued to decrease in weight even after the time when the KOH solutions in the CO₂-free environment stabilized, illustrating that in a CO₂-containing environment, the KOH solutions would tend to dry out. These solutions eventually at least partially crystallized to form K₂CO₃ crystals. This crystallization occurs substantially because CO₂ undergoes carbonation, because of the presence of atmospheric CO₂. Carbonation substantially causes the evaporation of the water in the KOH electrolyte. The resulting K₂CO₃ crystals have substantially no hygroscopic property, unlike the original KOH.

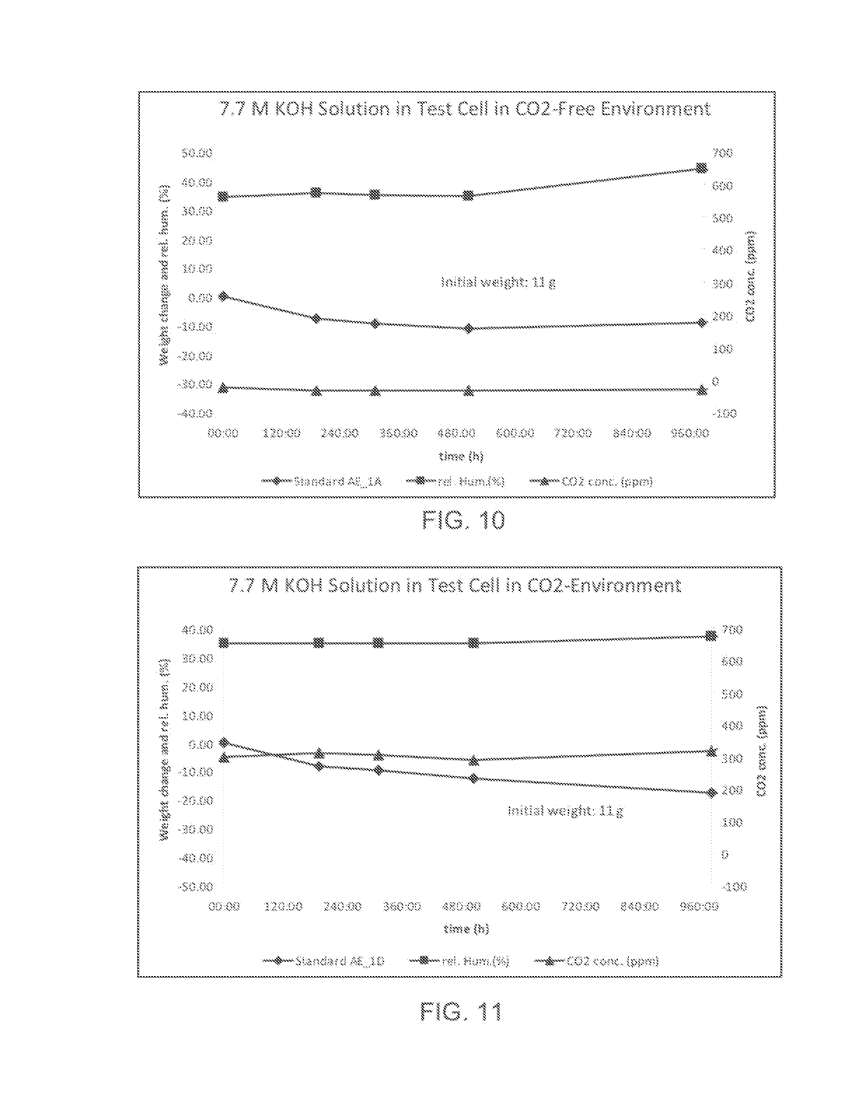

FIGS. 10 and 11 illustrate substantially the same behavior as shown in FIGS. 8 and 9, with the difference being that the results shown in FIGS. 10 and 11 were obtained using prismatic cell prototypes having an air electrode but no metal electrode (instead of using a watchglass as in FIGS. 8 and 9). Test cells were prepared using various types of air electrodes, with the concentration of the KOH electrolyte being 7.7 M. Again, the KOH solutions in the CO₂-containing environment tended to dry out over time, as evidenced by the downward sloping lines indicative of continued weight loss in the electrolyte as shown in the FIG. 11 graph. Although the electrolyte in the prismatic cells takes longer to dry out than the electrolyte in the watchglass, it is believed that this is due to the fact that the air electrode in the prismatic battery reduces the diffusion rate of the water from within the cell.

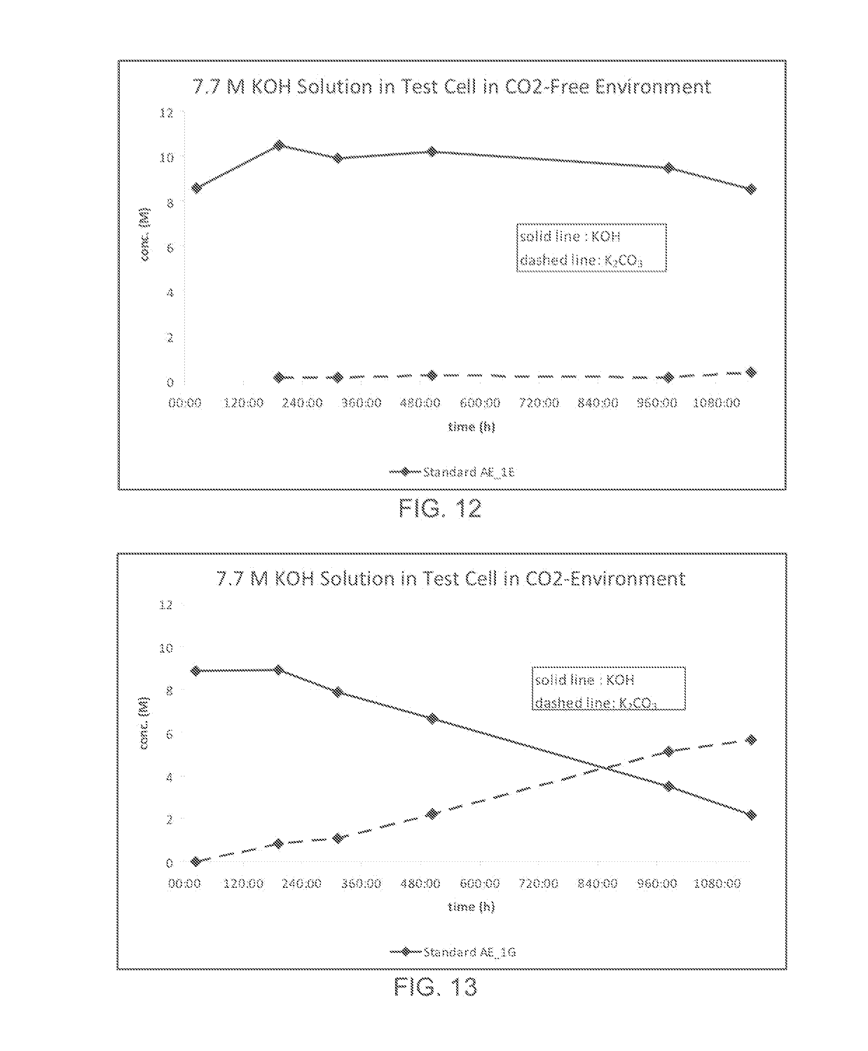

FIGS. 12 and 13 are graphs illustrating the results of an experiment intended to examine the effects of CO₂ on the concentration of hydroxides in a prismatic prototype metal-air battery over time. The results indicate that the hydroxide concentration is reduced by the presence of CO₂. In the CO₂-free environment, FIG. 12 shows that the concentrations of hydroxides remained relatively constant over time, whereas in the CO₂-containing environment, FIG. 13 shows a dramatic reduction in hydroxide concentration with time. As noted by FIGS. 12 and 13, in the CO₂-free environment, the concentration of K₂CO₃ remains relatively constant at a very low value, while in the presence of CO₂, the K₂CO₃ increases with increasing time.

Hydroxide concentration also affects the capacity of the metal-air battery anode. With decreasing hydroxide concentration, the capacity of the battery tends to decrease. Accordingly, CO₂ can both dry out the metal-air battery and decrease the capacity of a metal-air battery by decreasing the concentration of hydroxides in the metal-air battery. This again illustrates the importance of preventing CO₂ from entering the battery.

Prior to the investigation by applicants, it does not appear that the available technical literature has described the mechanism for the water loss in zinc-air batteries as a function of temperature, relative humidity, and CO₂ concentration in air. As illustrated by the experiments described above, little or no water loss was observed for KOH solutions when exposed to air with no or low CO₂ gas concentrations. However, the rate of water loss is significantly higher when exposed to air with relatively higher CO₂ gas concentration. Without wishing to be bound to any particular theory, the Applicants believe that this water loss is experienced because KOH undergoes carbonation, which is caused by CO₂, as described by the following formula:

KOH+CO₂←→K₂CO₃

and that the following mechanism may describe the phenomena of dry out and flooding of metal-air (e.g., zinc-air) batteries: CO₂ (g) is converted to CO₂ (aq), followed by the conversion of CO₂ (aq) to CO₃²⁻ (aq) due to the high OH⁻ concentration (the reaction consumes 2 OH⁻). The OH⁻ concentration then drops, and with the reduction in OH⁻ concentration, the partial pressure of water vapor increases as the K₂CO₃ (aq) has low hygroscopic properties. With increased concentration due to water loss, and when the solubility product is reached, precipitation of K₂CO₃(s) may be observed. Because KOH is hygroscopic and K₂CO₃ has low hygroscopic properties, as KOH is converted to K₂CO₃ in the presence of CO₂, the stability of the battery is compromised (e.g., it dries out, shortening its lifespan).

It should be noted that, while KOH (and other hydroxide solutions) were known to be hygroscopic, the above-discussed test results and this mechanism show empirically that KOH tends to dry out in the presence of CO₂, which does not appear to have been established before the inventors' efforts as a failure mechanism for metal-air (e.g., zinc-air) battery storage.

The results described with respect to 8-13 illustrate that KOH continues to dry out in a CO₂-containing environment over time (exhibited by the continued weight loss with time, which is attributable to water loss), and that when the KOH is instead placed in a CO₂-free environment, the weight of the electrolyte remains substantially constant over time (indicating that the electrolyte does not dry out). Additionally, as shown by the fact that the tests performed in a CO₂-free environment gain or lose electrolyte depending on the humidity of the surrounding environment, the humidity of the surrounding environment can have a significant impact on battery flooding or dry out. Together, these test results illustrate the importance of understanding the impact of humidity and CO₂ when designing a metal-air battery, and suggest that it would be advantageous to prevent or mitigate against water vapor and CO₂ transport that can produce deleterious effects on the long-term performance of such batteries.

One possible approach to reducing or eliminating transport of water vapor and CO₂ is to include an oxygen-selective membrane such as the siloxane membranes described above. Such an approach is described in more detail, for example, in U.S. patent application Ser. No. 12/828,016, filed Jun. 30, 2010, the disclosure of which is incorporated herein by reference.

Another approach, as will be described in more detail below, is to utilize ionic liquids and/or deep eutectic solvents within the metal-air batteries in order to mitigate against water vapor and CO₂ transport. It should be understood to those reviewing the present disclosure that although the following description will describe the application of these concepts in the context of a coin or button cell battery configuration, these concepts may also find utility in other metal-air battery configurations, including AA, AAA, D-size cells, etc., as well as in the prismatic and flow battery configurations shown and described herein (e.g., the description of the possibilities for the separator layer 20 below should be interpreted as applying in a similar manner to the separator layers 120 and 220 illustrated with respect to the embodiments shown in FIGS. 4-7).

An ionic liquid (IL) is a salt in the liquid state, and is generally formed of ions or short-lived ion pairs. Such materials may also be referred to, for example, as ionic melts, ionic fluids, fused salts, liquid salts, or ionic glasses. Ionic liquids are generally electrically conductive, non-polar, and exhibit low vapor pressures.

The inclusion of an ionic liquid within the metal-air battery will now be described with reference to FIG. 2, in which the separator layer 20 is provided between the metal electrode 12 and the air electrode 14 (and more particularly, between the electrolyte 18 and the air electrode 14). The separator layer 20 is configured to prevent short circuiting of the battery 10 by providing electrical isolation between the metal electrode 12 and the air electrode 14. According to an exemplary embodiment, the separator layer includes a thin, porous, film or membrane formed from a polymeric material (referred to herein as a “separator”). In some exemplary embodiments, the separator layer includes a separator that is made of polypropylene or polyethylene that has been treated to develop hydrophilic pores that are configured to fill with the electrolyte 18. In other exemplary embodiments, the separator may be made of other suitable materials suited for preventing short circuiting of the battery 10 and/or that includes hydrophilic pores. As will be made clearer by the description below, the term “separator layer” is intended herein to encompass a variety of embodiments that include one or more individual separators and may also include one or more liquid layers, ionic exchange membranes, and polymer electrolyte films.

The electrolyte 18 is shown disposed substantially between the metal electrode 12 and the air electrode 14 according to an exemplary embodiment. According to such an embodiment, the separator layer 20 is provided as a single separator, as illustrated generally in FIG. 2 (although according to other exemplary embodiments, the separator layer 20 may include more than one separator).

The electrolyte 18 is not consumed by the electrochemical reaction within the battery 10, but, rather, is configured to provide for the transport of hydroxyl ions (“OH⁻”) from the air electrode 14 to the metal electrode 12 during discharge, and, where the battery 10 is a secondary system, to provide for transport of hydroxyl ions from the metal electrode 12 to the air electrode 14 during charge.

The electrolyte is disposed within some of the pores of the metal electrode 12 and some of the pores of the air electrode 14. According to one exemplary embodiment, the electrolyte may be partially absorbed into the air electrode (e.g., by capillary forces) to provide for a three-phase zone with a high surface area for the air electrode catalyst(s) (where a polymer electrolyte is used, the three phase boundary may be established by casting a film from a liquid suspension onto the air electrode and then removing the solvents to form a polymer layer). The electrolyte may further be evenly distributed within the metal electrode, helping prevent uneven current distribution in the metal electrode as the reaction moves from the surface of the zinc electrode therethrough. One approach is to combine (e.g., mix, stir, etc.) the electrolyte with the metal (e.g., zinc) particles in the metal electrode, forming a slurry or paste that is filled into the can or pressed or calendared into an electrode. According to other exemplary embodiments, the distribution and location of the electrolyte may vary.

According to an exemplary embodiment, the electrolyte 18 includes an ionic liquid, either in pure form or mixed with water (e.g., 10 weight percent water) and/or an alkaline electrolyte that has high ionic conductivity and/or high reaction rates for the oxygen reduction/evolution and the metal oxidation and reduction reactions (e.g., NaOH, LiOH, KOH, etc.). For ease of reference, it should be understood that where an electrolyte is discussed herein as including KOH, other suitable alkaline electrolytes may be used in place of KOH (e.g., NaOH, LiOH, etc.). According to other embodiments, the electrolyte may include salt water or other salt-based solutions that give sufficient conductivity for the targeted applications (e.g., for marine/military applications, etc.).

The electrolyte that includes an ionic liquid is configured to be relatively highly ionically conductive to provide for high reaction rates for the oxygen reduction/evolution and the metal oxidation/reduction reactions, which in turn helps the battery achieve a desired current density. The ionic liquid also advantageously may provide the electrolyte with a relatively low vapor pressure point, which allows the electrolyte to have a relatively low evaporation rate, helping to prevent (e.g., resist, slow, etc.) drying out of the electrolyte. Drying out of the electrolyte results in increased ohmic resistance (e.g., as a result of the decreased OH⁻ conductivity), which would generally result in a loss in the power density and a decrease in the efficiency of the battery. In some exemplary embodiments, the ionic liquids may be hygroscopic so that they are able to take water from the environment, thus reducing the tendency for the electrolyte to dry out over time.

Other potential advantages of using an ionic liquid in the electrolyte include the fact that some ionic liquids may assist the electrolyte in stabilizing the three phase boundary within the air electrode by binding with polymers included in the air electrode, some may be configured to dissolve oxygen, and some may be configured to provide for more uniform depositions and a different reaction mechanism due to their effect on the charge and discharge reactions (e.g., improving the discharge properties of the battery).

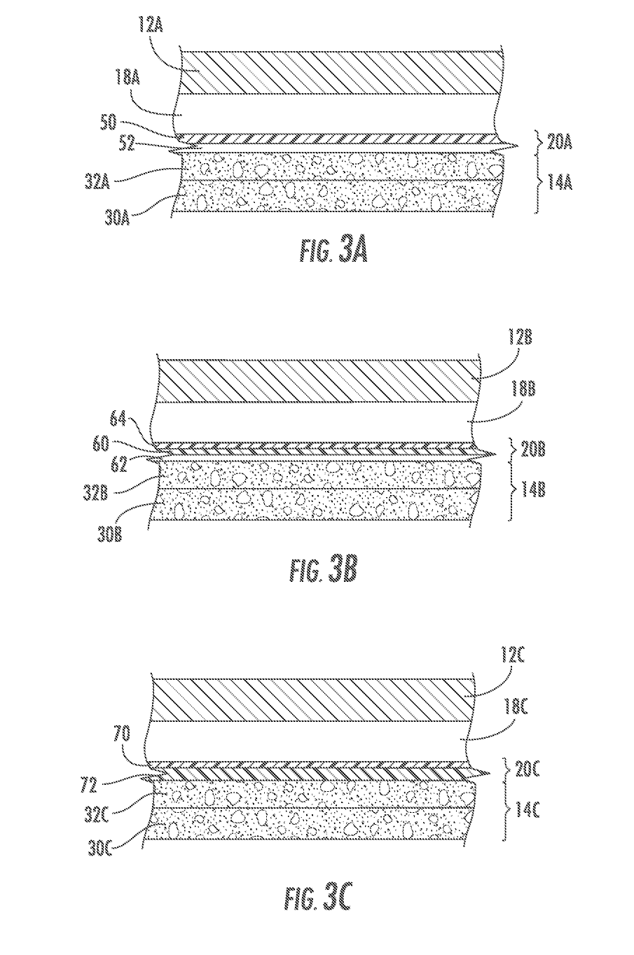

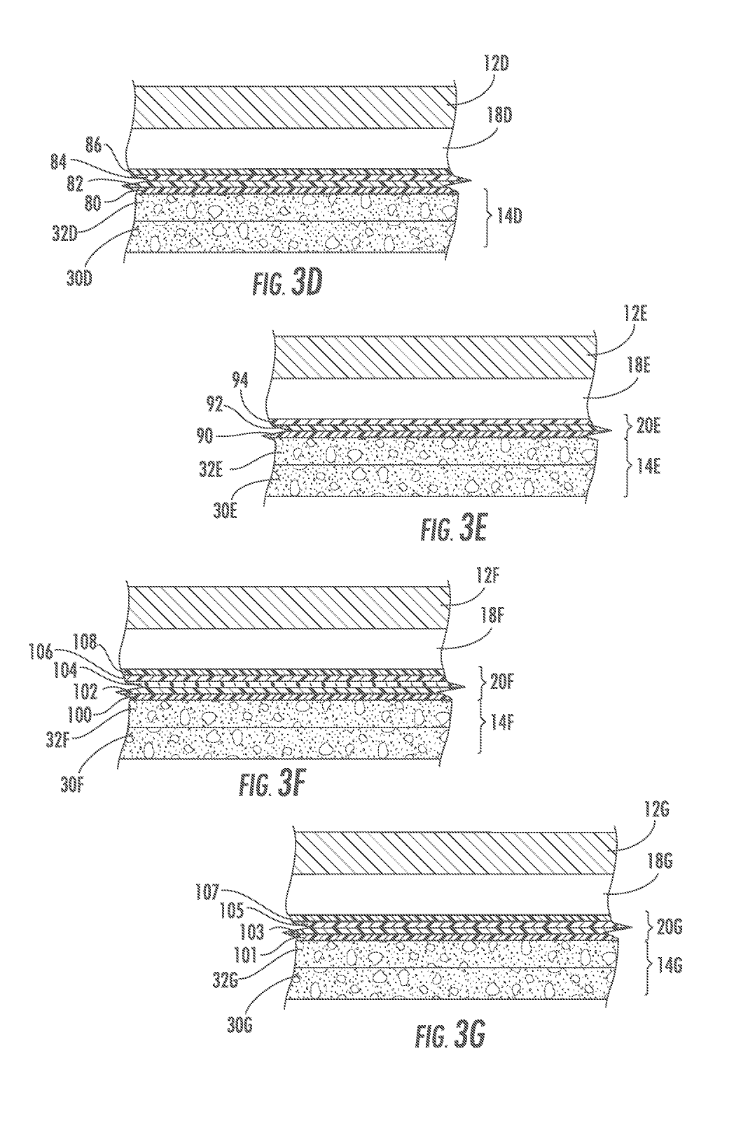

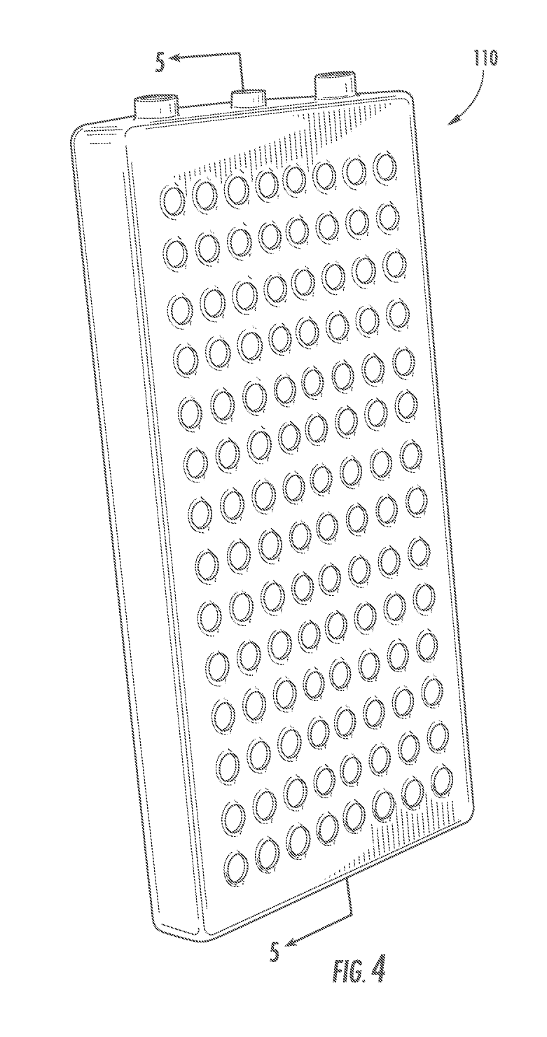

Although the ionic liquid may be included within the electrolyte 18 (either in pure form or mixed with water and/or KOH), according to another exemplary embodiment, the ionic liquid may be provided as an electrolyte that is separated from another more traditional electrolyte. As shown in FIG. 3A, for example, the air electrode 14A (which includes a gas diffusion layer 30A and an active layer 32A) is separated from an electrolyte 18A (which may be a more conventional alkaline electrolyte such as KOH, NaOH, LiOH, etc., alone or mixed with water, or any other suitable electrolyte) and the metal electrode 12A by a separator layer 20A. The separator layer 20A includes a separator 50 (e.g., a porous polymeric separator having any desired configuration; according to an exemplary embodiment, the separator is a nonwoven separator such as a PPAS-14 separator commercially available from Shanghai ShiLong Hi-Tech Co., Ltd Chinese Academy of Science (CAS) of the People's Republic of China or a microporous separators such as a 3401 separator commercially available from Celgard of Charlotte, N.C., although other types of separators may be used according to other exemplary embodiments; according to an exemplary embodiment, the PPAS-14 separator has a thickness of approximately 140 micrometers and the 3401 separator has a thickness of approximately 20 micrometers, although the thicknesses of the separator may vary according to other exemplary embodiments). An ionic liquid electrolyte 52 provided between the separator 50 and the air electrode 14A. The ionic liquid electrolyte 52 may be provided in pure form or mixed with KOH and/or water. In such an embodiment, the ionic liquid electrolyte penetrates into the air electrode.

According to an exemplary embodiment as shown in FIG. 3B, an ion exchange membrane may be included within the battery. The air electrode 14B (which includes a gas diffusion layer 30B and an active layer 32B) is separated from an electrolyte 18B (which may be provided as a KOH or other suitable electrolyte) and the metal electrode 12B by a separator layer 20B. The separator layer 20B includes a separator 60 (e.g., a porous polymeric separator) and an ionic liquid electrolyte 62 provided between the separator 60 and the air electrode 14B. The ionic liquid electrolyte 62 may be provided in pure form or mixed with KOH and/or water. In such an embodiment, the ionic liquid electrolyte penetrates into the air electrode. An ion exchange membrane 64 is provided between the separator 60 and the electrolyte 18B, although it should be understood that the ion exchange membrane may be placed elsewhere in the separator layer 20B.

Ion exchange membranes or separators may be formed or include a material that is generally selective for the transport of either cations or anions. According to a particular embodiment, the ion exchange membrane is selective only to anions, including but not necessarily limited to hydroxyl (OH⁻) ions (in such a case, the ion exchange membrane may be referred to as an anion exchange membrane). The anion exchange membrane is intended to be active to prevent cations and particles from passing between the air electrode and the metal electrode of the battery. According to an exemplary embodiment, the ion exchange membrane may also act to limit the ability of certain anionic species (e.g., zincate) from passing between the air electrode and the metal electrode. Without wishing to be bound to a particular theory, it is believed that the selectivity for certain types of anions may depend at least in part on the size of the anion, so that larger anions such as zincate may be less likely to traverse the ion exchange membrane, while smaller anions such as OH⁻ may readily traverse the membrane.

According to an exemplary embodiment, the ion exchange membrane is provided in the form of a film (e.g., a sheet, layer, etc.). Examples of such membranes include Fumion AM, Fumion AP, or Fumion APrf ion exchange membranes, each of which are commercially available from FuMA-Tech GmbH of St. Ingbert, Germany. According to an exemplary embodiment, the Fumion AM and Fumion AP membranes may have a thickness of approximately 50 micrometers and the Fumion APrf may have a thickness of approximately 65 micrometers, although the thicknesses of the membranes may vary according to other exemplary embodiments. It will be appreciated that other types of ion exchange membranes may be used in place of or in addition to the foregoing membrane types. Additionally, although FIG. 3B illustrates a single ion exchange membrane, it should be understood that more than one such membrane (e.g., two or more layers, etc.) of the same or differing types of ion exchange membranes may be used according to other exemplary embodiments, and may be disposed adjacent to one another or may be spaced a distance apart.

The ion exchange membrane is provided as a solid polymer film or sheet that limits (e.g., controls, regulates, etc.) the transport of materials within the battery. In a case where an ion exchange membrane is attached to the air electrode (e.g., in a lamination process or other process that applies heat and/or pressure), some of the ion exchange material within the membrane will soak into the air electrode. This in turn fills some of the pores with a plastic material, and may help to provide additional stability for the three phase boundary of the air electrode (e.g., by helping to separate the oxygen reduction reaction from the oxygen evolution reaction). According to an exemplary embodiment, the ion exchange membrane is configured to be stable in an alkaline solution, has relatively high conductivity over a temperature rage of 10° C. to 300° C.

According to an exemplary embodiment, the ion exchange membrane may be soaked in an electrolyte (e.g., KOH) prior to assembling it with the air electrode. For example, the ion exchange membrane may be dipped into a KOH solution and, while still wet, may be coupled or joined (e.g., laminated onto) the air electrode by heat pressing, hot sealing, or other suitable methods. The pre-soaking of the ion exchange membrane is intended to activate the ion exchange material by providing a source of OH⁻ ions for the ion exchange membrane. According to other exemplary embodiments, the ion exchange membrane may not be pre-soaked in an electrolyte, in which case electrolyte from within the cell may slowly soak into the membrane after assembly of the cell to activate the ion exchange membrane.

According to another exemplary embodiment, rather than using commercially-available ion exchange membranes, an ion exchange material may be formed directly onto the surface of the air electrode to form the ion exchange membrane or may be formed on another surface and transferred to the surface of the air electrode as described above with respect to commercially-available membranes. For example, according to one exemplary embodiment, a solution of ion exchange material in a solvent (e.g., Fumion AM ion exchange material in a solvent of N′N-Dimethylformamide (DMF)) may be spread onto a tray as a film. An optional sheet of material (e.g., a 50 micrometer film of Mylar, commercially available from DuPont) may be provided on the tray to protect the tray while casting the film. The film may then be dried (e.g., under ambient conditions, and under a fume hood according to an exemplary embodiment) for a period of time (e.g., 1.5 to 2.0 hours) until the film may be easily peeled off of the tray (or off of the sheet of material). The thickness of the resulting film may be selected based on desired performance parameters, and is a function of the amount of material applied to the surface to form the film (e.g., according to other exemplary embodiments, a deposited film thickness of 200 micrometers may shrink to approximately 70 micrometers after it is dried). According to an exemplary embodiment, the film has a thickness of between approximately 10 and 200 micrometers, although other thicknesses are possible according to other exemplary embodiments. The film may then be applied to an air electrode (e.g., on the active layer side) by hot pressing (e.g., for approximately 2 minutes at 80 bar and a temperature of 70° C., although the parameters may differ depending on factors such as the thickness of the film, the composition of the film, and other factors). The air electrodes may then be assembled into a battery along with an oxygen distribution layer or diffuser on the gas diffusion side of the air electrode, a separator soaked in an alkaline electrolyte such as 11M KOH (e.g., a nonwoven separator such as a PPAS-14 separator commercially available from Shanghai ShiLong Hi-Tech Co., Ltd Chinese Academy of Science (CAS) of the People's Republic of China), a microporous separator (e.g., a 3401 separator commercially available from Celgard of Charlotte, N.C.), and an electrolyte and metal anode (e.g., provided as a metal paste including zinc and an alkaline electrolyte such as KOH).

According to another exemplary embodiment, the separator layer may be differently configured so that the ionic liquid may be provided in one or more different polymeric layers that may be a part of a separator layer (e.g., soaked into a polymeric separator such as that shown as separator 20 in FIG. 2 or incorporated directly into a polymeric layer). For example, according to an exemplary embodiment shown in FIG. 3C, an electrolyte 18C (e.g., an alkaline electrolyte such as KOH, NaOH, LiOH, etc., alone or combine with water, or any other suitable electrolyte) may be separated from an air electrode 14C (which includes a gas diffusion layer 30C and an active layer 32C) by a separator layer 20C. The separator layer 20C includes a separator 70 provided between the electrolyte 18C and the air electrode 14C. A polymer layer or film 72 includes an ionic liquid blended into a copolymer (e.g., polyvinylidenefluoride-hexafluoropropylene, or PVDF-HFP, which may be used as a polymer electrolyte). The ionic liquid is provided at between approximately 20 and 60 weight percent of the layer 72 according to an exemplary embodiment, although different mixtures may be used according to other exemplary embodiments. The polymer layer 72 is provided as a film that is porous and holds the ionic liquid in place on the air electrode 14C. According to an exemplary embodiment, the polymer layer 72 has a thickness of approximately 30 micrometers, although different thicknesses may be used according to other exemplary embodiments.

FIGS. 2 and 3A-3C illustrate a variety of possible arrangements for a separator layer for a metal-air battery that incorporate an ionic liquid material. While only a few combinations have been illustrated, it should be appreciated by those reviewing the present disclosure that other combinations may also be possible. For example, a different number of layers may be used according to other exemplary embodiments, and such layers may be any desirable combinations of ion exchange membranes, separators (of any suitable type), and polymer electrolyte layers including a polymeric material mixed with an ionic liquid material at any desired loading level.

One advantageous feature of ionic liquids in metal-air batteries is that they tend to have low solubility for CO₂. In a metal-air battery application where CO₂ has been shown to have deleterious effects on the long-term performance of the battery, the use of ionic liquids may advantageously mitigate some of the negative effects of CO₂.

There are several considerations that may apply when selecting an ionic liquid for use in a particular metal-air battery application.

First, although most salts that melt without decomposing or vaporizing generally yield an ionic liquid, for practical purposes, only those ionic liquids that would be stable as a liquid (i.e., not crystallize) at the temperatures in which metal-air batteries would be utilized would generally be selected for incorporation within a metal-air battery. For example, it may be desirable for the ionic liquid to maintain stability within a temperature range of between approximately 5° C. and 50° C. In one exemplary embodiment, it may be further desirable for the ionic liquid to maintain stability within a temperature range of approximately −20° C. to 90° C. or within a larger temperature range.

Second, it may be desirable for the vapor pressure of the ionic liquid to be relatively low (e.g., so that it is relatively stable against environmental exposure). In one exemplary embodiment, it may be desirable for the vapor pressure of the ionic liquid to exhibit less that approximately one percent weight loss over a one-week period when stored at 50° C.

Third, it may be desirable for the conductivity of the ionic liquid to be relatively high. In one exemplary embodiment, it may be desirable for the conductivity of the ionic liquid to be between approximately 1 and 10 mS/cm at 25° C. In other exemplary embodiments, it may be desirable for the conductivity of the ionic liquid to be greater than 0.1 mS/cm at 25° C.

Fourth, it may be desirable for the ionic liquid to be stable within approximately a 1.2V or greater polarization window between the anode and the cathode. In one exemplary embodiment, it may be desirable for the ionic liquid to be stable within approximately a 2V or greater polarization window between the anode and the cathode. In another exemplary embodiment, it may be desirable for the ionic liquid to be stable within approximately a 2.5V or greater polarization window between the anode and the cathode.

Fifth, it may be desirable for the ionic liquid to contribute to improved electrochemical performance of the electrodes over the life of the metal-air battery. According to an exemplary embodiment, the ionic liquid may be combined (e.g., mixed, etc.) with one or more inorganic salts containing OH⁻ (e.g., NaOH, KOH, LiOH, etc.) to form an ionic liquid electrolyte. The resultant electrolyte is intended to be stable over time (e.g., the inorganic salts will not degrade the ionic liquid, etc.) and to maintain water in the hydroxide solution over time (e.g., the resultant electrolyte will not degrade into salt crystals in an ionic liquid solution when exposed to relatively low or high humidities, or relatively low or high temperatures). One potential mechanism that would lead to instability of the electrolyte over time relates to the pH of the electrolyte solution. If the pH is too high, the organic components of the ionic liquid may break down.

According to an exemplary embodiment, the ionic liquid may be configured to be combinable (e.g., mixable, etc.) with one or more organic molecules that have alkaline properties (e.g., it may be combinable with alkaline organic electrolytes that may find utility in metal-air batteries). In some exemplary embodiments, the ionic liquid may be partially formed with OH⁻ as the anion. In other exemplary embodiments, the ionic liquid is combined with the one or more organic molecules that have alkaline properties by using a anion that forms a ionic liquid. In still other exemplary embodiments, the organic molecule may be an organic alkaline material that is combinable or combined with the ionic liquid and that is intended to act as an activator for the electrochemical reactions such that the organic anion releases its OH— group or forms an OH— group during charge and discharge of the cell. According to an exemplary embodiment, In(OH)₂ may be added to a water-based electrolyte including an ionic liquid.

Thin films of polymers and/or other novel materials can be included in the solution/coating material applied to a substrate to form a thin film. Inclusion of these thin films in air electrodes can be achieved using a number of production methods (e.g., a spray coating process, spin coating, screen printing, dip coating, etc.). In some exemplary embodiments, the polymers may be ion selective materials or gas selective materials. An ion selective polymer may provide for control of the electrolyte inter phase in an air electrode. A gas selective material (e.g., siloxane) may provide for control of the gas transport in an air electrode. In other exemplary embodiments, binders (e.g., PTFE, PE, PP, etc.) can be included in a solution to control the mechanical properties, gas and electrolyte penetration. In some exemplary embodiments, a thin film is applied that includes an ionic liquid that may provide improved control of the humidity interaction (vapor loss/gain).

Because of their ability to help resist battery dry out, ionic liquids may allow for new metal-air battery configurations and applications, and in particular those applications which require long stand-by life time. Ionic liquids provide the option to have a more open air electrode structure since there is less need for humidity management, provide increased surface area for the oxygen reaction because less binder material can be used, and allow for more catalysts to be included in the air electrode because larger carbon particles may be used or may be used in greater proportions. An additional advantage is that the size and/or number of holes allowing oxygen into the battery may be increased.

In selecting an ionic liquid for use in a metal-air battery, the miscibility of the ionic liquid may be taken into account. For example, in a case where a KOH electrolyte is being utilized in the metal-air battery and it is desirable to incorporate the ionic liquid in a way where it will interact with the electrolyte, it would be advisable to select an ionic liquid that is miscible with KOH. Of course, ionic liquids that are miscible with one type of solvent may not be miscible with other types of solvents.

A variety of ionic liquids have been reported as retaining their liquid characteristics at room temperature. The cations for such ionic liquids may include, for example, organic cations such as 1-alkyl-3-methylimidazolium, 1-alkylpyridinium, N-methyl-N-alkylpyrrolidinium and ammonium ions. A variety of anions may be used in conjunction with such cations, for example, simple halides, inorganic anions such as tetrafluoroborate and hexafluorophosphate, and large organic anions like bistriflimide, triflate or tosylate. Non-halogenated organic anions such as formate, alkylsulfate, alkylphosphate or glycolate may also be used. The melting point of 1-butyl-3-methylimidazolium tetrafluoroborate with an imidazole skeleton has been reported as being around −80° C. (−112° F.), and appears as a colorless liquid with high viscosity at room temperature. According to an exemplary embodiment, the ionic liquid may include a subsitituted pyrrolidolidinium or substituted methylimidazolium (e.g., 2,3-dimethylimidazolium) cation (e.g., with substituents including methyl, ethyl, and buyl, etc.). According to another exemplary embodiment, the ionic liquid may be an ammonium or phosphonium acetate salt. In addition to the foregoing, Table 1 lists the cations and anions for a number of ionic liquids that may be utilized in conjunction with metal-air batteries according to various exemplary embodiments.

TABLE 1

| Cation | Anion |
|---|---|
| butyl-triethylammonium | bis(trifluoromethylsulfonyl)imide |
| 1-butyl-1-methylpyrrolidinium | dicyanamide |
| 1-butyl-1-methylpyrrolidinium | tetracyanoborate |
| 1-butyl-1-methylpyrrolidinium | trifluoromethanesulfonate |
| 1-butyl-1-methylpyrrolidinium | tris(pentafluoroethyl)- |
| | trifluorophosphate |
| 1-butyl-1-methylpyrrolidinium | triflate |
| 1-butyl-3-methylimidazolium | 1,1,2,2-tetrafluoroethansulfonat |
| 1-butyl-3-methylimidazolium | acetate |
| 1-butyl-2,3-dimethylimidazolium | acetate |
| 1-ethyl-2,3-dimethylimidazolium | acetate |
| 1-ethyl-2,3-dimethylimidazolium | bis(trifluoromethylesulfonyl)imide |
| 1-ethyl-3-methylimidazolium | methylsulfonate |
| 1-ethyl-3-methylimidazolium | methylsulfonate +5% Cellulose |
| 1-ethyl-3-methylimidazolium | bis(trifluoromethylesulfonyl)imide |
| 1-ethyl-3-methylimidazolium | triflate |
| 1-methyl-1-propylpiperidinium | bis(trifluoromethylsulfonyl)imide |
| 1-methyl-1-propylpyrrolidinium | bis(trifluoromethylsulfonyl)imide |
| Tetra-N-butylammonium | bromide |
| Tetrahexylammonium | perchlorate |
| Tetra-N-butylammonium | picrate |
| Tetrapentylammonium | bromide |
| Tetra-N-hexylammonium | bromide |
| Tetra-N-butylammonium | iodide |
| Tetra-N-pentylammonium | iodide |
| Tetra-iso-pentylammonium | iodide |
| Tetra-N-hexylammonium | iodide |
| Tetra-N-heptylammonium | iodide |
| Tetra-N-pentylammonium | thiocyanate |
| Tetra-N-pentylammonium | nitrate |
| Tetra-N-hexylammonium | tetrafluoroborate |
| 1-Butyl-3-methylimidazolium | hexafluorophosphate |
| 4-Methyl-N-butylpyridinium | tetrafluoroborate |
| 1-Butyl-3-methylimidazolium | triiodide |
| 1-Ethyl-3-methylimidazolium | triiodide |
| 1-Ethyl-3-methylimidazolium | ethylsulfate |
| N-Butylpyridinium | tetrafluoroborate |
| 1-n-Octyl-3-methylimidazolium | hexafluorophosphate |
| 1-n-Octyl-3-methylimidazolium | tetrafluoroborate |
| 1-Butyl-3-methylimidazolium | nitrate |
| 1-Ethyl-3-methylimidazolium | hexafluorophosphate |
| 1-Methyl-3-methyl-imidazolium | methylsulfate |
| Tetrabutylammonium | chloride |
| 1-Ethyl-3-methyl-1H-imidazolium | tetrafluoroborate |
| 1-Butyl-3-methylimidazolium | tetrafluoroborate |
| 1,3-dimethylimidazolium | methoxyethylsulfate |
| 1-Butyl-3-methylimidazolium | chloride |
| Tetra-N-butylammonium | methanesulfonate |
| Tetra-N-butylammonium | trifluoromethanesulfonate |
| Tetra-N-butylammonium | benzenesulfonate |
| Tetra-N-butylammonium | butanesulfonate |
| Tetra-N-butylammonium | octanesulfonate |
| Tri-N-butylmethylammonium | butanesulfonate |
| Tri-N-butylmethylammonium | octanesulfonate |
| 1-Butyl-3-methylimidazolium | iodide |
| 1,3-Dimethylimidazolium | tetrachloroaluminate |
| 1-Ethyl-3-methylimidazolium | tetrachloroaluminate |
| 1-Propyl-3-methylimidazolium | tetrachloroaluminate |
| 1-Butyl-3-methylimidazolium | tetrachloroaluminate |
| 1,3-Dibutylimidazolium | tetrachloroaluminate |
| 1-Ethyl-3-methylimidazolium | nitrate |
| 1-Ethyl-3-methylimidazolium | nitrite |
| 1-Hexyl-3-methylimidazolium | chloride |
| 1-Octyl-3-methylimidazolium | chloride |
| Tetra-N-butylammonium | ethanesulfonate |
| Tetra-N-butylammonium | 4-toluenesulfonate |
| Tetra-N-butylammonium | nitrite |
| Tetra-N-butylammonium | tetra-N-butylborate |
| Tetra-N-butylammonium | sulfamate |
| Tetra-N-butylammonium | nitrate |
| Tetra-N-butylammonium | thiocyanate |
| Tetra-N-butylammonium | pentacyanopropenide |
| 1-Ethyl-3-methylimidazolium | chloride |
| Pyridinium | ethoxyethylsulfate |
| 1-Methyl-4-octylpyridinium | chloride |
| 1-Methyl-4-octylpyridinium | bromide |
| 1-Methyl-4-octylpyridinium | iodide |
| 1-Ethyl-3-methylimidazolium | hexafluoroniobate |
| 1-Ethyl-3-methylimidazolium | hexafluorotantalate |
| 1-Methyl-3-methyl-imidazolium | dimethylphosphate |
| 1-Decyl-3-methylimidazolium | chloride |
| 1-Hexyl-3-methylimidazolium | tetrafluoroborate |
| 1-Dodecyl-3-methylimidazolium | chloride |
| 1-Butyl-3-methylimidazolium | bromide |
| 1,3-Dimethylimidazolium | chloride |
| 1-Methyl-3-propylimidazolium | chloride |
| 1,3-Dibutylimidazolium | chloride |
| 1,2,3-Trimethylimidazolium | chloride |
| 1-Ethyl-3-methylimidazolium | bromide |
| 1-Ethyl-3-methylimidazolium | iodide |
| 1-i-Propyl-3-methylimidazolium | iodide |
| 1-Ethyl-2,3-dimethylimidazolium | chloride |
| 1-Ethyl-2,3-dimethylimidazolium | bromide |
| 1-Propyl-2,3-dimethylimidazolium | chloride |
| 2,4,5-Trimethylimidazolium | chloride |
| Pentamethylimidazolium | iodide |
| Tetraethylammonium | tetrafluoroborate |
| 1-Ethyl-3-methylimidazolium | tetrabromoaluminate(III) |
| 1-Butyl-3-methylimidazolium | methylsulfate |
| 1-Butyl-3-methyl-imidazolium | trifluoromethanesulfonate |
| 1-Butyl-3-methylimidazolium | tetrachloroferrate |
| 1-Ethyl-3-methylimidazolium | trifluoromethylsulfate |
| 1-Ethyl-3-methylimidazolium | dicyanamide |
| Tri-n-hexyl-n-tetradecylphosphonium | chloride |
| 1-(2-Hydroxyethyl)-3- | tetrafluoroborate |
| methylimidazolium | |
| 1-Ethyl-3-methylimidazolium | tetrachlorogallate |
| Triethylamine | hydrochloride 2[AlCl3] |
| 1-Hexyloxymethyl-3- | tetrafluoroborate |
| methylimidazolium | |
| 1-Butyl-3-methylimidazolium | 2-(2methoxyethoxy) ethyl sulfate |
| 1-Hexyl-3-methylimidazolium | trifluormethylsulfonate |
| 1-Octyl-3-methylimidazolium | trifluormethylsulfonate |

According to other exemplary embodiments, deep eutectic solvents may be used in a metal-air battery to combat the negative effects of water loss and CO₂ transport into the battery. The inventors have unexpectedly determined that deep eutectic solvents (sometimes abbreviated “DES”) may be advantageously used as the electrolyte in a metal-air battery or included in the electrolyte in a metal-air battery. Further, the use of deep eutectic solvents in the electrolyte of metal-air batteries allows for the use of metal-air batteries in many applications where metal-air battery use was previously foreclosed or complicated by humidity and CO₂ management issues, as discussed above.

A deep eutectic solvent (DES) is an ionic solvent that is a mixture of two or more components that forms a eutectic with a melting point much lower than either of the individual components (e.g., quaternary ammonium salts with hydrogen donors such as amines and carboxylic acids; chlorine chloride and urea; etc.). Compared to ordinary solvents, deep eutectic solvents also have a low volatility, are non-flammable, are relatively inexpensive to produce, and may be biodegradable.

One example of such a material is a DES formed of a mixture of choline chloride (2-hydroxyethyl-trimethylammonium chloride) and urea (e.g., in a 1:2 mole ratio). Choline chloride has a melting point of 302° C. while urea has a melting point of 133° C. The eutectic mixture of the two components, however, melts at a temperature as low as 12° C. Other deep eutectic solvents of choline chloride are formed with malonic acid (melting point of 0° C.), phenol (melting point of −40° C.) and glycerol (i.e., glycerine) (melting point of −35° C.).

According to various exemplary embodiments, the DES may be a mixture of glycerol and zinc bromide, a mixture of glycerol and zinc iodide, a mixture of glycerol and a hydrochloric salt of ethylamine, a mixture of urea and cholene chloride, a mixture of urea, choline chloride, and sodium sulfite. According to some exemplary embodiments, a deep eutectic solvent may be combined with choline hydroxide and/or sodium sulfate.

According to other exemplary embodiments, the deep eutectic solvent may include a first component that comprises a hydrogen bond donor and a second component that comprises a metal salt or a nitrogen salt (e.g., a halide-containing salt of amines or metals such as transition metals). According to various exemplary embodiments, the first component may be a hydroxyl, an amide, an amine, an aldehyde, a carboxylic acid, an organic acid, a urea, a thiourea, a diol, a glycerol, a choline chloride, a ethylammonium chloride, a choline bromide, a terabutylammonium chloride, a triethylbenzylammonium chloride, a zinc chloride, a acetylcholine chloride, a malonic acid, a formamide, an arabinose, a glucose, a xylose, or a combination thereof.

According to one particular exemplary embodiment, the DES is a mixture of glycerol and acetylcholine chloride. An electrolyte that included a deep eutectic solvent (formed of glycerol and acetylcholine chloride) mixed with 20% 7.5M KOH was tested, and exhibited 17% water uptake at 50° C. in an environment at 50% relative humidity. The electrolyte formed a clear, stable solution with good electrochemical properties when tested.

The DES may be incorporated into the battery in a variety of different manners. According to an exemplary embodiment, the electrolyte 18 may include a mixture of DES and an alkaline electrolyte such as KOH (and/or water or another suitable electrolyte according to other exemplary embodiments). Thus, as shown in FIG. 2, the separator layer 20 may include one or more polymeric separators that act to separate the electrolyte 18 including both the DES and the KOH from the air electrode 14.

According to other exemplary embodiments, the separator layer may be configured differently. For example, according to an exemplary embodiment shown in FIG. 3D illustrates a separator layer 20D provided between an electrolyte 18D and an air electrode 14D (which includes a gas diffusion layer 30D and an active layer 32D). The electrolyte 18D is provided adjacent the metal electrode 12D. The separator layer 20D includes four separate layers. A first layer 80 includes a DES (e.g., a mixture of glycerol and acetylcholine chloride) blended into a copolymer (e.g., polyvinylidenefluoride-hexafluoropropylene, or PVDF-HFP). The DES is provided at 33 weight percent of the first layer 80 according to an exemplary embodiment, although different mixtures may be used according to other exemplary embodiments. A second layer 82 includes a separator that is soaked in either KOH (e.g., 11M KOH) or a DES (e.g., a DES similar to that used in the first layer 80). A third layer 84 and a fourth layer 86 each include a separator soaked in KOH (e.g., 11M KOH). The separators of the third and fourth layers may be the same or different types of separators.

FIG. 3E illustrates a separator layer 20E provided between a electrolyte 18E and an air electrode 14E (which includes a gas diffusion layer 30E and an active layer 32E). The electrolyte 18E is provided adjacent the metal electrode 12E. The separator layer 20E includes three separate layers. A first layer 90 includes a separator soaked with a DES (e.g., a mixture of glycerol and acetylcholine chloride). A second layer 92 is provided as an ion exchange membrane. A third layer 94 includes a separator soaked in KOH (e.g., 11M KOH).

According to an exemplary embodiment shown in FIG. 3F, a traditional electrolyte 18F (e.g., KOH) and metal electrode 12F may be separated from an air electrode 14F (which includes a gas diffusion layer 30F and an active layer 32F) by a separator layer 20F. The separator layer 20B is shown as being formed of five separate layers. A first layer 100 includes a DES (e.g., a mixture of glycerol and acetylcholine chloride) blended into a copolymer (e.g., polyvinylidenefluoride-hexafluoropropylene, or PVDF-HFP, which may be used as a polymer electrolyte). The DES is provided at 33 weight percent of the first layer 100 according to an exemplary embodiment, although different mixtures may be used according to other exemplary embodiments. The first layer 100 is provided as a film that is porous and holds the DES in place on the air electrode 14F. A second layer 102 includes a separator (e.g., a nonwoven separator such as a PPAS-14 separator commercially available from Shanghai ShiLong Hi-Tech Co., Ltd Chinese Academy of Science (CAS) of the People's Republic of China) that is soaked in either KOH (e.g., 11M KOH) or a DES (e.g., a DES similar to that used in the first layer 60). A third layer 104 includes a separator (e.g., a microporous separator such as a 3401 separator commercially available from Celgard of Charlotte, N.C.) that is soaked in KOH (e.g., 11M KOH). A fourth layer 106 is provided as an ion exchange membrane. A fifth layer 108 includes a separator soaked in KOH (e.g., 11M KOH).

Other configurations may also be possible. FIG. 3G illustrates a separator layer 20G that separates a metal electrode 12G and an electrolyte 18G from an air electrode 14G (which includes a gas diffusion layer 30G and an active layer 32G). The separator layer 20G includes four separate layers. A first layer 101 is provided as a separator soaked with a DES (e.g., a mixture of glycerol and acetylcholine chloride). A second layer 103 includes a separator that is soaked in either KOH (e.g., 11M KOH) or a DES (e.g., a DES similar to that used in first layer 72). A third layer 105 and a fourth layer 107 each include a separator soaked in KOH (e.g., 11M KOH). The separators of the third and fourth layers may be the same or different types of separators.

FIGS. 2 and 3D-3G illustrate a variety of possible arrangements for a separator layer for a metal-air battery that incorporate a DES material. While only a few combinations have been illustrated, it should be appreciated by those reviewing the present disclosure that other combinations may also be possible. For example, a different number of layers may be used according to other exemplary embodiments, and such layers may be any desirable combinations of ion exchange membranes, separators (of any suitable type) soaked in DES and/or KOH, and polymer electrolyte layers including a polymeric material mixed with a DES material at any desired loading level.

It should be understood by those reviewing the present disclosure that ionic liquids and deep eutectic solvents described herein may be substituted for one another, for example, in any of the configurations show and described herein, and in particular, with respect to the configurations shown in FIGS. 2, 2A, and 3A-3G. For example, in any configuration where a DES is located within a porous polymeric separator (e.g., by soaking), according to other exemplary embodiments, an ionic liquid may be soaked into the separator along with or in place of the ionic liquid. Where an ionic liquid has been described as being provided as a liquid electrolyte between two layers (e.g., layers 52 and 62 in FIGS. 3A and 3B), a DES may be used in place of or in addition to the ionic liquid. Both DES and an ionic liquid may be used within a single battery. For example, an ionic liquid may be incorporated within a polymeric layer such as a polymeric electrolyte that is coupled to the air electrode, while a porous polymeric separator having a DES material soaked into it may also be used in the same battery.

In short, any combination of one or more of the following may be used within a metal-air battery (e.g., coin cell, button cell, prismatic cell, cylindrical cell, flow battery, or any other type of metal-air battery, whether now known or hereafter developed), and all such combinations are intended to be within the scope of this disclosure: (a) a liquid layer including any one or more of the following: a DES, an ionic liquid, water, and/or an electrolyte such as an alkaline electrolyte (e.g., KOH, NaOH, LiOH, etc.); (b) a polymeric separator having any one or more of the following materials absorbed therein: a DES, an ionic liquid, water, and/or an electrolyte such as an alkaline electrolyte (e.g., KOH, NaOH, LiOH, etc.); (c) a polymeric material (e.g., a copolymer such as PVDF-HFP) having an ionic liquid and/or DES blended therein, whether the polymeric material is coupled directly to the air electrode or located elsewhere within the battery; (d) an electrolyte mixed with the metal anode that includes any one or more of the following: a DES, an ionic liquid, water, and/or an electrolyte such as an alkaline electrolyte (e.g., KOH, NaOH, LiOH, etc.); (e) an ionic liquid and/or a DES soaked into an air electrode; (f) an ion exchange material, whether provided in the form of a membrane or integrated into other components within the battery; (g) a siloxane membrane.

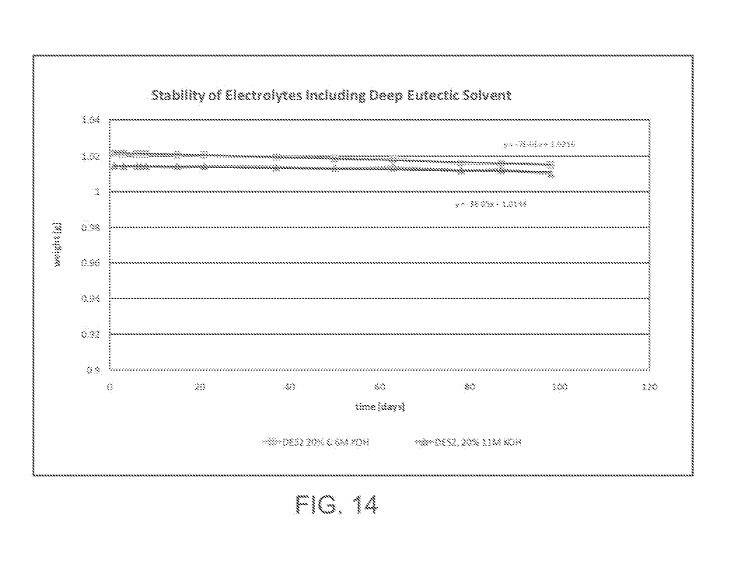

Referring now to FIGS. 14-24, test data illustrating the efficacy of a DES material in combating the adverse effects that may result from exposure of a metal-air battery electrolyte to the surrounding atmosphere will be discussed.

FIG. 14 illustrates the long-term stability of an electrolyte that includes DES. A first electrolyte was prepared as a mixture of glycerol/acetylcholine chloride and 6.6M KOH in an 80/20 ratio of DES to KOH. Another electrolyte was prepared as a mixture of glycerol/acetylcholine chloride and 11M KOH in an 80/20 ratio of DES to KOH. The two electrolytes were then exposed to the surrounding environment to determine whether the electrolyte would experience a weight loss comparable to that described above with respect to standard KOH electrolytes (see, e.g., FIGS. 10-13 and the accompanying description above). It should be noted that because these mixtures were close to equilibrium in terms of humidity with the surrounding environment, there was not an initial take-up or removal of moisture from the electrolytes. While a standard KOH electrolyte would be expected to lose a significant amount of its weight under these circumstances owing to the effects of water loss and CO₂, both of the DES/KOH mixtures showed very little weight loss over an extended period of 100 days. Accordingly, the addition of a DES such as a glycerol/acetylcholine chloride mixture advantageously appears to advantageously provide for stabilization of the electrolyte by preventing water loss that may be a result of exposure to the surrounding environment.

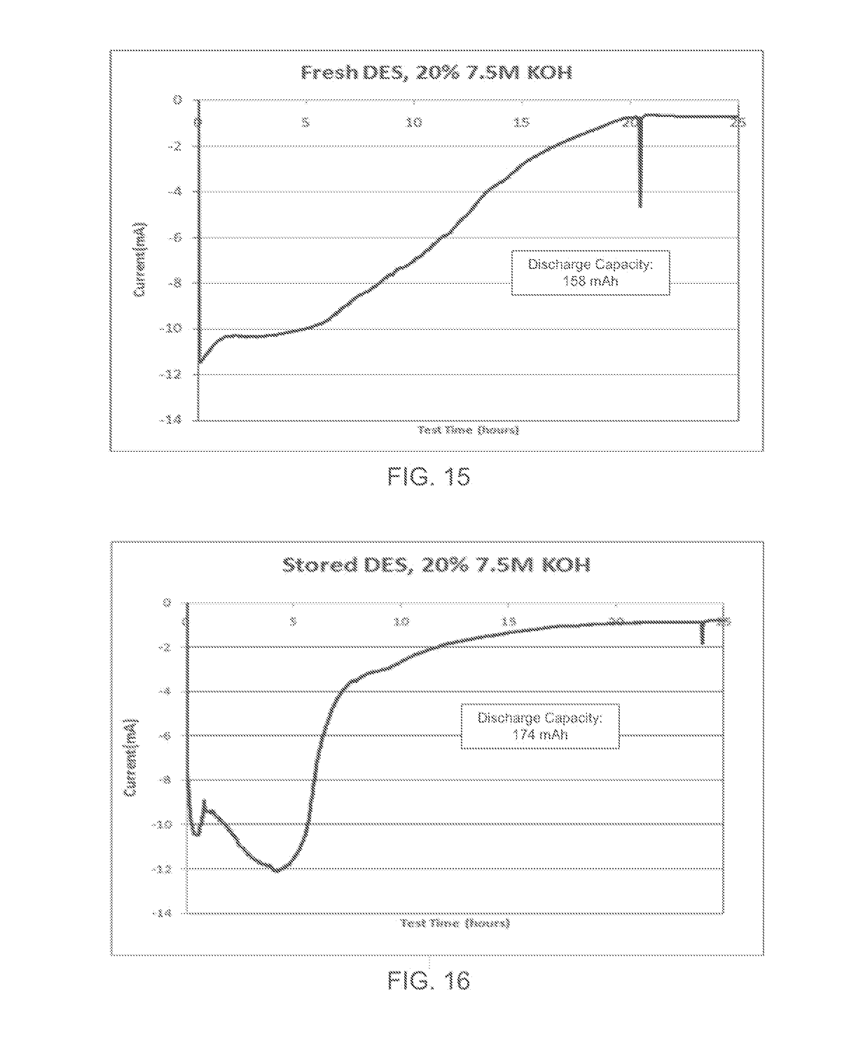

FIGS. 15 and 16 are graphs showing the current versus test time for two button or coin cells produced using either a fresh DES (e.g., a DES that was freshly prepared and not exposed to the surrounding atmosphere for any significant amount of time) and a stored DES (e.g., a DES that had been exposed to the surrounding atmosphere for 100 days. A first cell (FIG. 15) included a polymeric separator (e.g., a PPAS14 separator) soaked with an electrolyte that included a fresh glycerol/acetylcholine chloride DES material mixed with a 7.5M KOH solution, with the KOH solution provided at a level of 20 weight percent of the electrolyte. A separate ion exchange membrane was provided between a zinc paste that included a traditional KOH electrolyte mixed with zinc particles. Together, the polymeric separator and the ion exchange membrane formed a separator layer between the zinc paste and the air electrode. A second cell (FIG. 16) was assembled in a similar manner, but used a DES material in the polymeric separator that had been exposed to the surrounding atmosphere for 100 days. Each of the two cells were then discharged over a period of approximately 25 hours. FIGS. 15 and 16 illustrate the current during discharge for each of the cells, with the area under the curves (i.e., the area between the curves and the x-axis; current values are shown as negative because the current was measured at the air electrode for the battery instead of at the zinc electrode side) representing the total discharge capacity of each of the cells. The discharge capacity for the cell using a fresh DES material was 158 mAh, while the discharge capacity of the cell using a stored DES material was 174 mAh. This indicates that regardless of whether the DES is fresh or exposed to the surrounding atmosphere for an extended period, the resulting cells would be expected to provide similar discharge capacities. It should be noted that if a traditional metal-air battery using a standard electrolyte such as KOH were exposed to the surrounding atmosphere for an extended period (e.g., more than around 25 days), it would be expected that the battery would have zero discharge capacity as a result of drying out of the electrolyte.

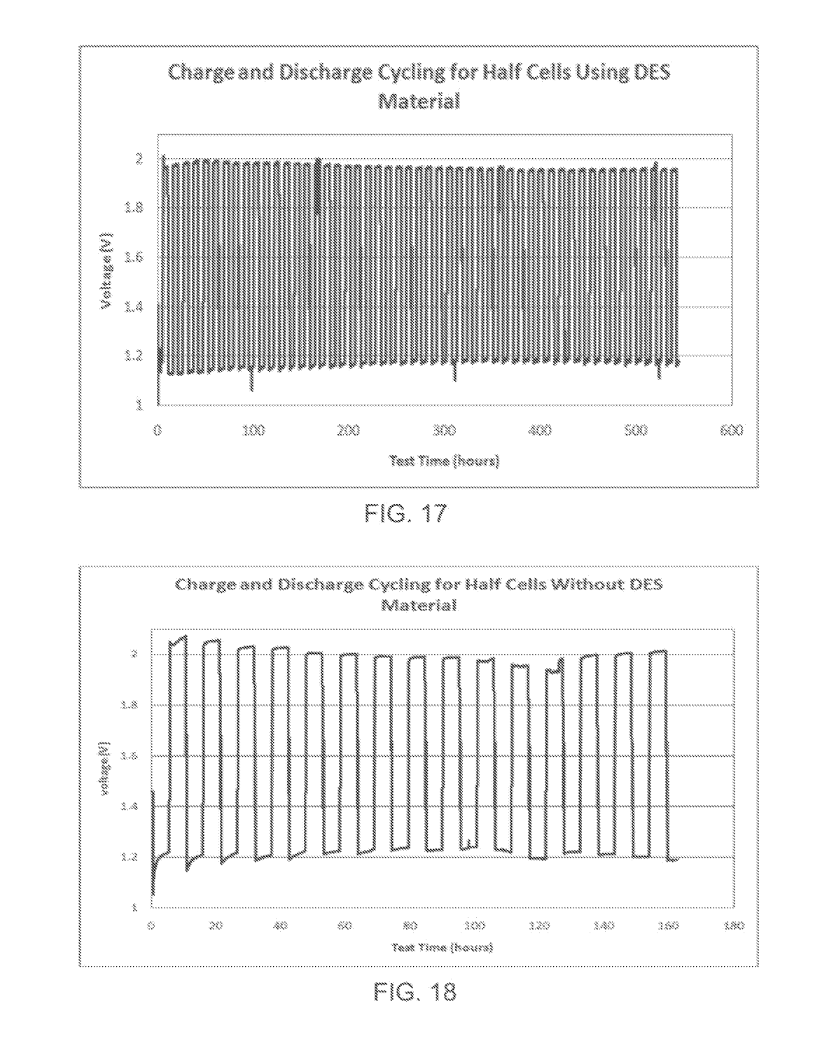

FIGS. 17 and 18 illustrate the effectiveness of using a DES material (e.g., a glycerol/acetylcholine chloride DES material) mixed in a polymer electrolyte material such as the PVDF-HDP material described above with respect to FIG. 3B. Air electrode half cells were produced in which a first half cell was produced using a polymer electrolyte laminated onto an air electrode, with the polymer electrolyte including 33 weight percent of a glycerol/acetylcholine chloride DES material mixed with a PVDF-HDP copolymer. A second baseline half cell was made without the polymer electrolyte, and instead used a traditional KOH electrolyte. Charge and discharge cycling was performed at 20 mA/cm² for successive 5 hour charge and 5 hour discharge cycles. The required charging voltage for the cells using the polymer electrolyte with a DES material (FIG. 17) was initially lower (e.g., below 2 volts) as compared to the baseline half cells (FIG. 18) which tended to decrease with successive cycles until it dropped below the 2 volt mark after approximately 60 hours. The adjustment over time of the cell illustrated with respect to FIG. 18 indicates that an extended charge/discharge formation cycle would be required for cells not utilizing the polymer electrolyte with DES incorporated therein, while such an extended formation process would not be required for cells using the polymer electrolyte/DES mixture. Additionally, FIG. 17 illustrates that the charge/discharge performance of the half cells using the polymer electrolyte/DES mixture were very stable, particularly after 200 hours of charging/discharging cycling.

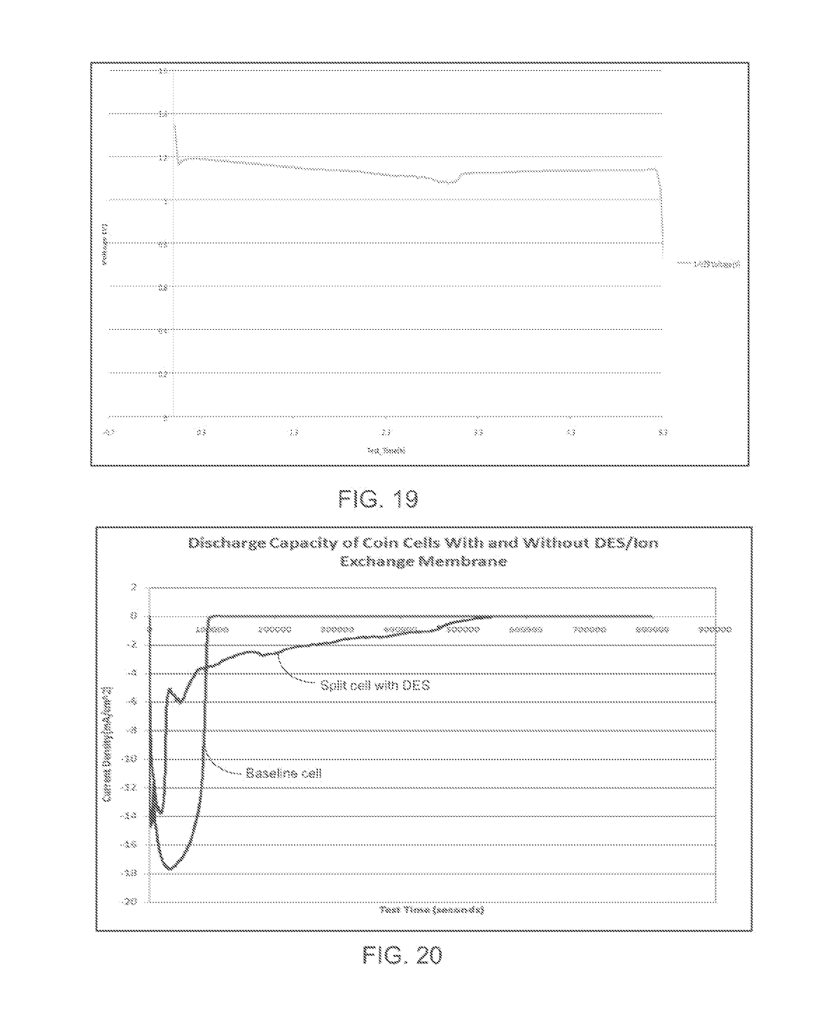

FIG. 19 illustrates that the same behavior would be expected of full cells (as opposed to half cells) utilizing the polymer electrolyte/DES mixture described with respect to FIG. 17. A coin cell was formed using the polymer electrolyte/DES mixture laminated onto the air electrode, and a 5 hour discharge was performed at a constant current of 10 mA. This graph illustrates that the air electrode needs no activation and provides high voltages (e.g., 1.1 to 1.2 V), consistent with half cell data obtained.

One concern in introducing features such as DES, ionic exchange membranes, and the like is that such features may adversely affect the capacity of the cells. FIG. 20 illustrates discharge data for two coin cells. A first coin cell included a glycerol/acetylcholine chloride DES material separated from a traditional KOH electrolyte by an ion exchange membrane (e.g., comprising Fumion AM, Fumion AP, or Fumion APrf, commercially available from FuMA-Tech GmbH of St. Ingbert, Germany). According to an exemplary embodiment, the ion exchange membrane has a thickness of between approximately 50 and 65 micrometers, although the thickness may vary according to other exemplary embodiments. The DES material was soaked into a wicking material in the form of a porous polymeric separator. A second coin cell was a baseline cell in which a traditional separator was provided between an electrolyte paste of zinc particles and KOH and the air electrode. Although the shape of the discharge curves differ, the capacity of each was approximately 250 mAh, indicating that the use of an ion exchange membrane and a DES material did not adversely affect the capacity of the cell.

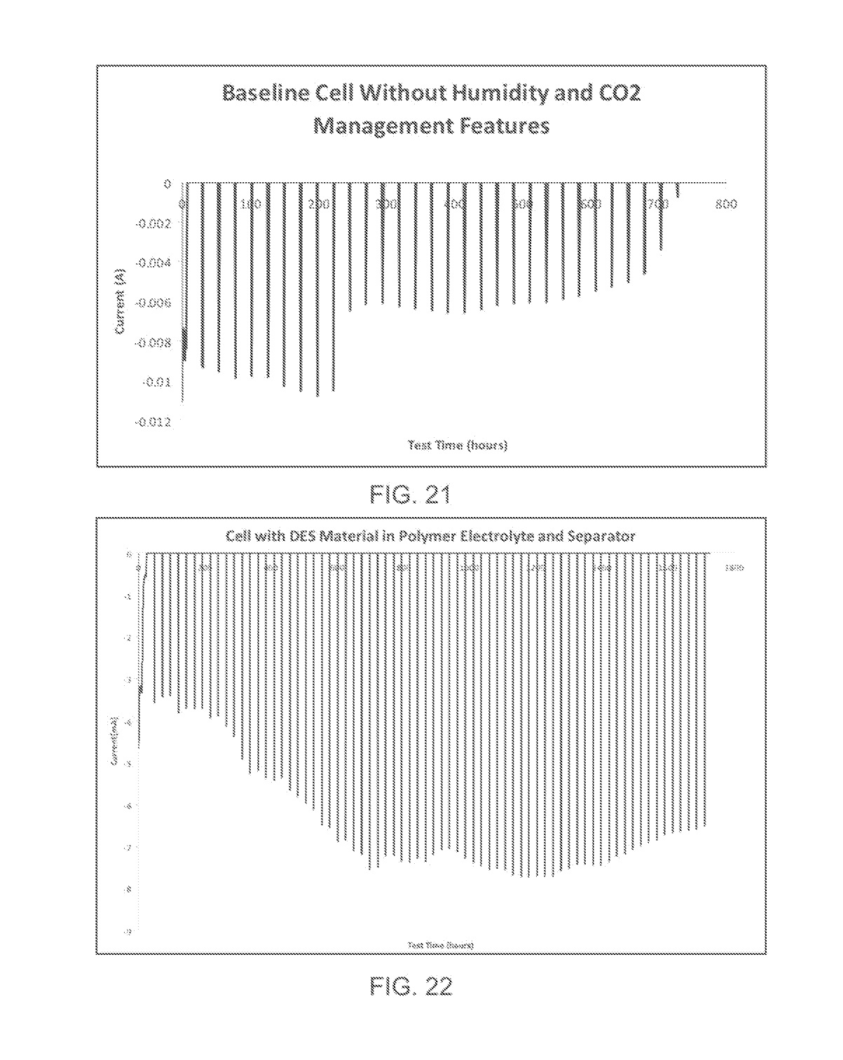

It has been experimentally determined that the use of a DES material such as a glycerol/acetylcholine chloride DES material may provide significant benefits for a metal-air battery by increasing its lifetime. While not wishing to be bound to a particular theory, it is believed that one reason for this positive development is that the DES combats the transport of water vapor and CO₂ that would eventually result in conventional cells experiencing electrolyte dry out. FIGS. 21 and 22 illustrate this phenomenon in more detail.

FIG. 21 illustrates the discharge capacity performance of a coin cell using a traditional electrolyte (KOH) and a conventional polymeric separator between a zinc electrode and an air electrode, without any provisions for the control of water vapor and CO₂. After approximately 700 hours of cycling in which the cells were discharged at 1 volt and rested at the open circuit voltage for the cell, the cell stopped functioning. In sharp contrast, FIG. 22 illustrates similar data for a coin cell including a glycerol/acetylcholine chloride DES material incorporated in a PVDF-HFP polymer electrolyte layer, with the DES material provided at 33 weight percent in the polymer electrolyte. An ion exchange membrane was also provided between the polymer electrolyte layer and the KOH electrolyte, and a DES material was included in a wicking layer (e.g., a porous polymeric separator in the form of a PPAS-14 separator) that was provided between the air electrode and the ion exchange membrane. As illustrated in FIG. 22, not only did the discharge currents continue to increase with time up to a point of approximately 700 hours, but after more than 1,700 hours, the battery continued to exhibit significant discharge current. Accordingly, unlike the cell with no humidity/CO₂ management features, the cell having a polymer electrolyte with a DES material prevented drying out of the electrolyte, which allows the battery to have a substantially longer working life.

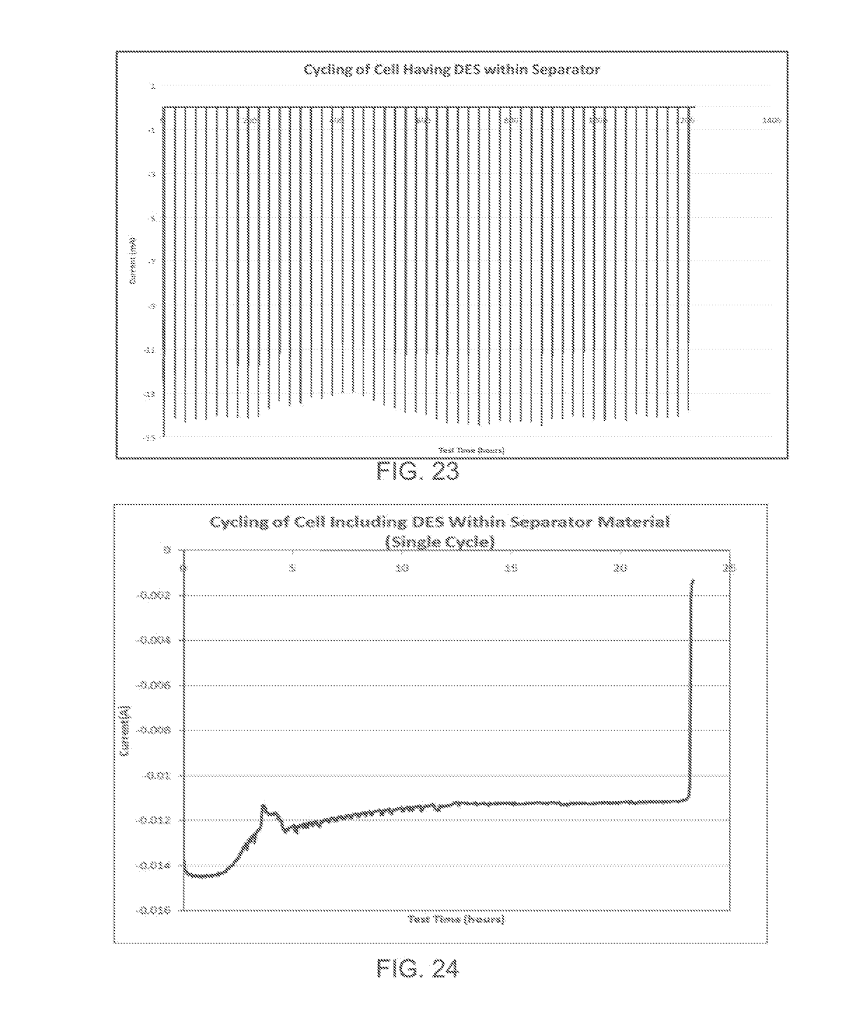

FIGS. 23 and 24 illustrate the discharge performance of a coin cell having a configuration similar to that shown in FIG. 3C, with a glycerol/acetylcholine chloride DES material soaked into two separators closest to the air electrode (i.e., layers 70 and 72), with two additional separators soaked in KOH. FIG. 24 illustrates the performance during a single discharge cycle. As compared to a baseline cell in which the maximum current is approximately 0.01 A (see FIG. 21), FIGS. 23 and 24 illustrate that the coin cell using the DES material absorbed into a separator provides a 40-50 percent improvement in maximum current (e.g., with a maximum current between 0.014 and 0.015 A), and after nearly 1,200 hours of testing, continued to retain its performance. As described above with respect to FIG. 21, the baseline cells dried out and stopped performing after about 700 hours of testing.

Various combinations of materials, structures, application methods, methods of manufacture, and applications discussed herein may be used within the scope of this disclosure. Also, while the description included herein is primarily directed to batteries, the concepts disclosed also apply to fuels cells and other electrochemical conversion devices having desired configurations.

The metal-air batteries described herein may be used singularly or in combination, and may be integrated into or with various systems or devices to improve efficiency, address energy demands, etc. The metal-air batteries described herein may be used in a wide range of applications. For example, the battery may be used in large systems and devices (e.g., power levels in the kW range), where improving environmental aspects (e.g., the environment external to the battery and the effect of this environment on the chemical reaction within the battery) of the metal-air battery may provide for significant gains in performance (e.g., energy conversion and storage at high efficiency). Also, the battery may be used in smaller systems (power levels in the W range), where advances in consumer electronics provide opportunities for energy conversion and storage provided in a desirable size and having a relatively long lifespan

Coin cells, prismatic cells, and cylindrical cells such as those described herein may be used in any application where such batteries may find utility, including, for example, hearing aids, headsets (e.g., Bluetooth or other wireless headsets), watches, medical devices, and other electronic devices such as (but not limited to) cameras, portable music players, laptops, phones (e.g., cellular phones), toys, portable tools. Metal-air flow batteries can provide energy storage and conversion solutions for peak shaving, load leveling, and backup power supply (e.g., for renewable energy sources such as wind, solar, and wave energy). The flow batteries may allow for the reduction of energy generation related emissions (e.g., greenhouse gases), and may also be used in a manner intended to improve the efficiency of the public utility sector. Flow batteries may also be used in for providing backup power, for example, for residential or commercial buildings such as homes or office buildings. In the automotive context, metal-air flow batteries may also be used to provide motive power for an electric vehicle (e.g., a hybrid-electric vehicle, plug-in hybrid electric vehicle, pure electric vehicle, etc.), to provide backup power for the battery (e.g., as a range-extender), to provide power for other vehicle electric loads such as the electronics, GPS/navigation systems, radios, air conditioning, and the like within the vehicle, and to provide for any other power needs within the vehicle (it should be noted that metal-air batteries having prismatic, cylindrical, or other configurations may also be used to provide power in the foregoing vehicle applications, for example, where a number of batteries are used in conjunction with each other to form a battery pack, module, or system).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the metal-air battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present inventions.

What is claimed is:

1. A metal-air battery comprising:
a metal electrode;
an air electrode; and
at least one of an ionic liquid and a deep eutectic solvent provided within the metal-air battery.

2. The metal-air battery of claim 1, wherein the metal-air battery comprises a liquid layer comprising at least one of an ionic liquid and a deep eutectic solvent.

3. The metal-air battery of claim 1, wherein the metal-air battery comprises a polymeric separator having at least one of an ionic liquid and a deep eutectic solvent absorbed therein.

4. The metal-air battery of claim 1, wherein the metal-air battery comprises a polymeric material having at least one of an ionic liquid and a deep eutectic solvent blended therein.

5. The metal-air battery of claim 4, wherein the polymeric material comprises a copolymer of polyvinylidenefluoride and hexafluoropropylene.

6. The metal-air battery of claim 1, wherein the metal-air battery comprises an electrolyte mixed with the metal electrode that comprises at least one of an ionic liquid and a deep eutectic solvent.

7. The metal-air battery of claim 1, wherein the metal-air battery comprises at least one of an ionic liquid and a deep eutectic solvent soaked into the air electrode.

8. The metal-air battery of claim 1, wherein the metal-air battery comprises an ion exchange membrane.

9. The metal-air battery of claim 1, wherein the metal-air battery comprises a siloxane membrane.

10. The metal-air battery of claim 1, wherein the metal-air battery includes a deep eutectic solvent that is mixed with at least one of water and an alkaline electrolyte.

11. The metal-air battery of claim 1, wherein the metal-air battery includes an ionic liquid that is mixed with at least one of water and an alkaline electrolyte.

12. The metal-air battery of claim 1, further comprising a polymeric separator, wherein an ionic liquid is provided between the separator and the air electrode.

13. The metal-air battery of claim 12, wherein an alkaline electrolyte is provided between the metal electrode and the separator.

14. The metal-air battery of claim 1, further comprising a porous polymeric separator between the metal electrode and the air electrode and a deep eutectic solvent within pores of the porous polymeric separator.

15. The metal-air battery of claim 1, further comprising a separator layer provided between the air electrode and the metal electrode, wherein the separator layer comprises a plurality of polymeric separators, and wherein at least one of the polymeric separators is soaked with a deep eutectic solvent.

16. The metal-air battery of claim 1, wherein the ionic liquid or deep eutectic solvent are provided in an amount sufficient to reduce the impact of the environment surrounding the metal-air battery may have on the life of the battery.

17. The metal-air battery claim 1, wherein the metal-air battery is a coin cell.

18. The metal-air battery of claim 1, wherein the metal-air battery has a prismatic or cylindrical configuration.

19. The metal-air battery of claim 1, wherein the metal-air battery is a flow battery and the air electrode is provided as part of a reaction tube for the flow battery.

20. A metal-air battery comprising:
a metal anode;
an air electrode;
an electrolyte provided between the metal anode and the air electrode; and
at least one polymeric separator between the metal anode and the air electrode;
wherein at least one of an ionic liquid and a deep eutectic solvent is provided within the electrolyte, within the polymeric separator, or in a layer of material coupled to the air electrode.

21. The metal-air battery of claim 20, wherein the polymeric separator is porous and has an ionic liquid or a deep eutectic solvent absorbed in pores of the separator.

22. The metal-air battery of claim 20, wherein the metal-air battery comprises a polymeric material coupled to the air electrode and having at least one of an ionic liquid and a deep eutectic solvent blended therein.

23. The metal-air battery of claim 20, wherein the metal-air battery comprises at least one of an ionic liquid and a deep eutectic solvent soaked into the air electrode.

24. The metal-air battery of claim 20, wherein the metal-air battery comprises an ion exchange membrane.

25. The metal-air battery of claim 20, wherein the metal-air battery comprises a siloxane membrane.

26. The metal-air battery of claim 20, wherein the metal-air battery includes a deep eutectic solvent that is mixed with at least one of water and an alkaline electrolyte.

27. The metal-air battery of claim 20, wherein the metal-air battery includes an ionic liquid that is mixed with at least one of water and an alkaline electrolyte.

28. The metal-air battery of claim 20, further comprising a separator layer provided between the air electrode and the metal electrode, wherein the separator layer comprises a plurality of polymeric separators, and wherein at least one of the polymeric separators is soaked with a deep eutectic solvent.

29. The metal-air battery of 20, wherein the metal-air battery is a coin cell, a prismatic battery, a cylindrical battery, or a flow battery.

30. A metal-air battery comprising:
a metal anode;
an air electrode;
an electrolyte provided between the metal anode and the air electrode; and
at least one polymeric separator between the metal anode and the air electrode;
wherein at least one of an ionic liquid and a deep eutectic solvent is provided adjacent the air electrode.

31. The metal-air battery of claim 30, wherein the electrolyte comprises at least one of an alkaline electrolyte and water.

32. The metal-air battery of claim 30, wherein the electrolyte further comprises an ionic liquid.

33. The metal-air battery of claim 30, further comprising a polymeric material provided adjacent the air electrode, and wherein at least one of an ionic liquid and a deep eutectic solvent is within the polymeric material.

34. The metal-air battery of claim 33, wherein the polymeric material is a porous polymeric separator and at least one of an ionic liquid and a deep eutectic solvent is provided within pores of the separator.

35. The metal-air battery of claim 33, wherein the polymeric material is a polymer electrolyte and at least one of an ionic liquid and a deep eutectic solvent is blended within the polymer electrolyte.

36. The metal-air battery of claim 30, wherein the metal-air battery comprises at least one of an ion exchange membrane or a siloxane membrane.

37. The metal-air battery of 20, wherein the metal-air battery is a coin cell, a prismatic battery, a cylindrical battery, or a flow battery.
